(19) United States
(12) Patent Application Publication
(10) Pub. No.: US 2018/0084931 A1
(43) Pub. Date: Mar. 29, 2018

(54) TRANSMISSION APPARATUS, BLADE, AND MOUNTING POSITION SPECIFICATION METHOD

(71) Applicant: FUJITSU LIMITED, Kawasaki-shi (JP)

(72) Inventors: Tetsuya YOKOYAMA, Kawasaki (JP); Takashi HONDA, Kawasaki (JP)

(73) Assignee: FUJITSU LIMITED, Kawasaki-shi (JP)

(21) Appl. No.: 15/668,130

(22) Filed: Aug. 3, 2017

(30) Foreign Application Priority Data
Sep. 23, 2016 (JP) 2016-186338

(51) Int. Cl. A47G 21/14; H04W 4/02

(52) U.S. Cl. CPC A47G 21/14; B24D 15/02; H04W 4/025

(57) ABSTRACT

A transmission apparatus includes a plurality of blades mounted in a juxtaposed relationship in an open rack and including a first blade and a second blade disposed next to the first blade, wherein the second blade includes: a sensor, and a processor coupled to the sensor and configured to: receive first position information indicating a mounting position of the first blade from the first blade, measure a distance between the first blade and the second blade using the sensor, and calculate second position information indicating a mounting position of the second blade based on the first position information and the measured distance.

### CROSS-REFERENCE TO RELATED APPLICATION

This application is based upon and claims the benefit of priority of the prior Japanese Patent Application No. 2016-186338, filed on Sep. 23, 2016, the entire contents of which are incorporated herein by reference.

### FIELD

The embodiments discussed herein are related to a transmission apparatus, a blade, and a mounting position specification method.

### BACKGROUND

As a relay apparatus used for communication through a network, a transmission apparatus that includes a plurality of blades is used. As an example of a transmission apparatus, there is a transmission apparatus in which a plurality of blades are mounted on a rack called shelf. In the transmission apparatus mentioned, the plurality of blades are electrically coupled to each other by being inserted into slots provided on a wiring board called backboard attached to the rear face of the rack.

On the other hand, as another example of a transmission apparatus, a transmission apparatus is disclosed in which a plurality of blades are mounted on an open rack. The open rack does not include a backboard including wiring lines. Therefore, communication between the plurality of blades is performed by wireless communication or by wire communication using a wire such as a cable for exclusive use or a local area network (LAN) cable. As a related art, for example, Japanese Laid-open Patent Publication No. 6-274253, Japanese Laid-open Patent Publication No. 2004-240967 or the like is disclosed.

In the transmission apparatus in which a shelf is used, it may be recognized by the backboard in which one of the slots in the shelf each blade is mounted. Therefore, a manager of the transmission apparatus may specify the mounting position of each of the plurality of blades in the shelf. However, in the transmission apparatus in which the open rack is used, since the backboard wiring lines are not provided, it is difficult for the manager of the transmission apparatus to specify the mounting position of each of the plurality of blades. It is desirable that, also where the open rack is used, the mounting position of each of the plurality of blades may be specified.

### SUMMARY

According to an aspect of the embodiments, a transmission apparatus includes a plurality of blades mounted in a juxtaposed relationship in an open rack and including a first blade and a second blade disposed next to the first blade, wherein the second blade includes: a sensor, and a processor coupled to the sensor and configured to: receive first position information indicating a mounting position of the first blade from the first blade, measure a distance between the first blade and the second blade using the sensor, and calculate second position information indicating a mounting position of the second blade based on the first position information and the measured distance.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a view depicting an example of a system in a first embodiment;

FIG. 2 is a view depicting an example of a functional block diagram of a blade in the first embodiment;

FIG. 3 is a view depicting an example of a hardware configuration of a blade;

FIGS. 4A and 4B are views depicting examples of perspective views of a blade;

FIG. 5 is a flow chart illustrating a process for specifying a positional relationship with a different blade, which is executed by each of a plurality of blades in the first embodiment;

FIG. 6 is a view illustrating an example of a distance information table;

FIG. 7 is a view illustrating an example of a format of a response confirmation frame;

FIG. 8 is a view illustrating an example of a communication state table at S105;

FIG. 9 is a view illustrating an example of a communication state table at S108;

FIG. 10 is a view illustrating an example of a communication state table at S111;

FIG. 11 is a view depicting an example of disposition of a plurality of blades in a transmission apparatus in the first embodiment;

FIG. 12 is an example of a sequence diagram of a process for specifying a positional relationship with a different blade, which is executed by each of a plurality of blades in the first embodiment;

FIG. 13 is a flow chart illustrating a process for specifying a mounting position in an open rack, which is executed by each of a plurality of blades in the first embodiment;

FIG. 14 is a view illustrating an example of a format of a request frame;

FIG. 15 is a view illustrating an example of data stored in respective fields of a request frame at an initial stage at S202;

FIG. 16 is a view illustrating an example of a format of a position information table;

FIGS. 17A and 17B are views illustrating data stored into a position information table;

FIG. 18 is a view illustrating an example of data stored into a request frame to be generated newly at S207;

FIG. 19 is an example of a sequence diagram of a process for specifying a mounting position, which is executed by each of a plurality of blades in the first embodiment;

FIGS. 20A, 20B, and 20C are views illustrating examples of position information tables stored in different ones of the plurality of blades depicted in FIG. 11;

FIGS. 21A and 21B are views illustrating examples of information displayed on a screen of a display device;

FIG. 22 is a view depicting an example of a system in a second embodiment;

FIG. 23 is a functional block diagram of a reference blade in the second embodiment;

FIG. 24 is a view illustrating an example of an overall position information table;

FIG. 25 is a flow chart illustrating a process for acquiring data of a mounting position from a different blade, which is executed by a reference blade in the second embodiment;

FIG. 26 is a flow chart illustrating an example of a process for generating and transmitting a request frame at S303;

FIG. 27 is a view illustrating an example of a format of a request frame;

FIG. 28 is a view illustrating an example of data stored in respective fields of a request frame at an initial stage at S304;

FIG. 29 is a flow chart illustrating an example of a process for placing data of a response frame;

FIG. 30 is a view illustrating an example of a format of a response frame;

FIG. 31 is a view illustrating data stored into an overall position information table;

FIG. 32 is a flow chart illustrating a process for specifying a mounting position in an open rack, which is executed by each of a plurality of blades other than a reference blade in the open rack in the second embodiment;

FIG. 33 is a flow chart illustrating an example of a process for analyzing a frame at S402;

FIG. 34 is a flow chart illustrating an example of a process for generating and transmitting a response frame at S410;

FIG. 35 is a view illustrating data stored in respective fields of a response frame;

FIG. 36 is a flow chart illustrating an example of a process for transferring a frame at S417;

FIG. 37 is a view depicting an example of disposition of a plurality of blades in a transmission apparatus in the second embodiment;

FIG. 38 is a sequence diagram (part 1) of a process for specifying a mounting position, which is executed by each of a plurality of blades in the second embodiment;

FIG. 39 is a sequence diagram (part 2) of a process for specifying a mounting position, which is executed by each of a plurality of blades in the second embodiment;

FIG. 40 is a sequence diagram (part 3) of a process for specifying a mounting position, which is executed by each of a plurality of blades in the second embodiment;

FIG. 41 is a sequence diagram (part 4) of a process for specifying a mounting position, which is executed by each of a plurality of blades in the second embodiment;

FIG. 42 is a view illustrating an example of an overall position information table stored in each of the plurality of blades depicted in FIG. 37;

FIG. 43 is a view depicting an example of a functional block diagram of a reference blade in a third embodiment;

FIG. 44 is a view depicting an example of a functional block diagram of each of blades other than a reference blade in an open rack in the third embodiment;

FIG. 45 is a view depicting an example of disposition of a plurality of blades in a transmission apparatus in the third embodiment;

FIG. 46 is a flow chart illustrating a process for specifying a positional relationship with a different blade, which is executed by each of a plurality of blades other than a reference blade in the third embodiment;

FIG. 47 is a view illustrating an example of a distance information table;

FIG. 48 is an example of a sequence diagram of a process for specifying a positional relationship with a different blade, which is executed by each of a plurality of blades in the third embodiment;

FIG. 49 is a view depicting an example of a system in a fifth embodiment;

FIG. 50 is a flow chart illustrating a process for specifying a mounting position in an open rack, which is executed by each of a plurality of blades in the fifth embodiment;

FIG. 51 is a view depicting an example of a system in a sixth embodiment;

FIG. 52 is a flow chart illustrating a process for acquiring data of a mounting position from a different blade mounted above a reference blade, which is executed by the reference blade in the sixth embodiment;

FIG. 53 is a flow chart illustrating an example of a process for transmitting a request frame in the sixth embodiment;

FIG. 54 is a view illustrating an example of a format of a request frame in the sixth embodiment;

FIG. 55 is a flow chart illustrating an example of a process for placing data of a response frame at S510;

FIG. 56 is a flow chart illustrating a modification to a process for specifying a mounting position in an open rack, which is executed by a reference blade in the first embodiment; and

FIG. 57 is a flow chart illustrating a modification to a process for specifying a mounting position in an open rack, which is executed by a blade other than a reference blade in the first embodiment.

### DESCRIPTION OF EMBODIMENTS

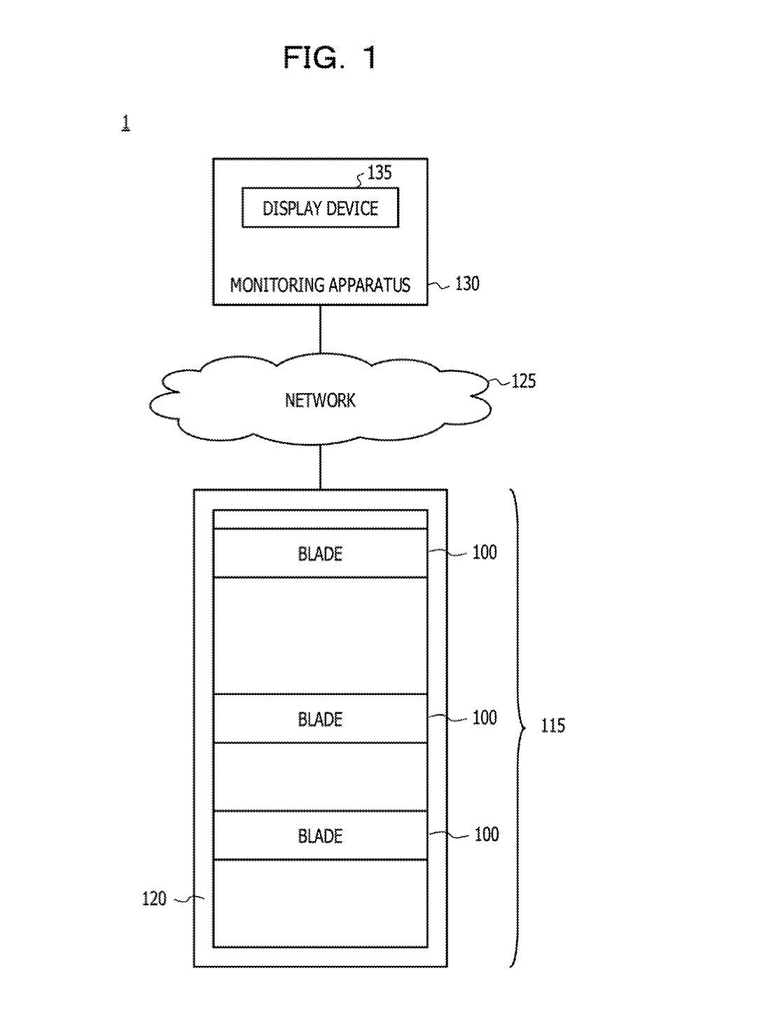

In the following, embodiments are described in detail with reference to FIGS. 1 to 57.

### First Embodiment

In the following, a first embodiment is described with reference to FIGS. 1 to 21.

FIG. 1 is a view depicting an example of a system in the first embodiment. As depicted in FIG. 1, a system 1 includes a transmission apparatus 115 and a monitoring apparatus 130. The transmission apparatus 115 and the monitoring apparatus 130 are coupled such that they may communicate with each other through a network 125.

The transmission apparatus 115 includes an open rack 120 and a plurality of blades 100 mounted in such a form that they are individually accommodated in the open rack 120. The open rack 120 is a housing that does not have a backboard. Each of the blades 100 is, for example, an interface card, a switch card that performs switching of a transmission path between a plurality of interface cards, or a control card for controlling a plurality of interface cards or a switch card.

The monitoring apparatus 130 is an apparatus that is used by a manager of the transmission apparatus 115 to monitor the transmission apparatus 115. The monitoring apparatus 130 includes a display device 135 for displaying an image. The monitoring apparatus 130 acquires information of the mounting position of the plurality of blades 100 in the open rack 120 from the transmission apparatus 115, for example, by transmitting a measurement start command to the transmission apparatus 115. Then, the monitoring apparatus 130 displays the acquired information on the screen of the display device 135. Consequently, the manager may grasp a blade configuration of the transmission apparatus 115.

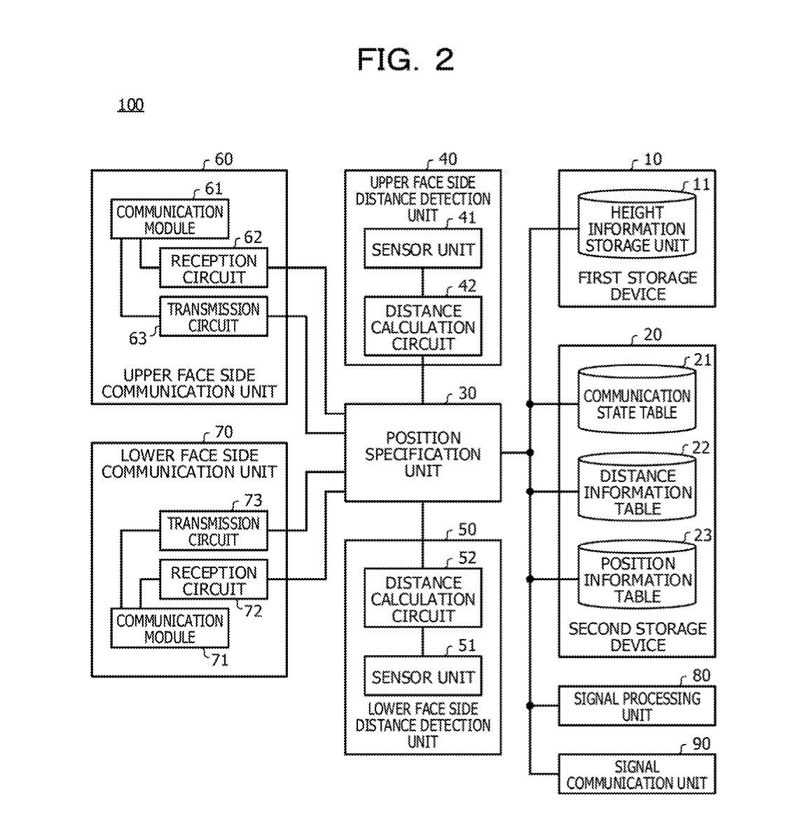

FIG. 2 is a view depicting an example of a functional block diagram of each blade in the first embodiment. The plurality of blades 100 in the first embodiment have functional blocks substantially similarly to each other for specifying their mounting positions. As depicted in FIG. 2, the blade 100 includes a first storage unit 10, a second storage unit 20, a position specification unit 30, an upper face side distance detection unit 40, a lower face side distance detection unit 50, an upper face side communication unit 60, a lower face side communication unit 70, a signal processing unit 80, and a signal communication unit 90. In the following, functions of the respective components are described.

The first storage unit 10 is hardware for storing programs executed by the position specification unit 30 and the signal processing unit 80. The first storage unit 10 has stored therein a mounting position specification program for specifying a mounting position in the open rack 120 of the blade 100. The first storage unit 10 includes a height information placement unit 11 for storing information of the apparatus height of the blade 100. The apparatus height is a thickness of the blade and is a distance between the upper face and the lower face of the blade measured in a direction parallel to the heightwise direction.

The second storage unit 20 is hardware for storing information used for a process executed by the position specification unit 30. For example, the second storage unit 20 has a communication state table 21, a distance information table 22, a position information table 23 and so forth stored therein. Details of the tables are hereinafter described.

The position specification unit 30 is hardware for executing a process for specifying a mounting position of each of the plurality of blades 100. The position specification unit 30 is coupled to the first storage unit 10, the second storage unit 20, the upper face side distance detection unit 40, the lower face side distance detection unit 50, the upper face side communication unit 60, and the lower face side communication unit 70 that provide information used for the process. A calculation unit, a decision unit, or a specification unit is an example of the position specification unit 30.

The upper face side distance detection unit 40 measures the distance to an upper object existing above the blade 100. The upper face side distance detection unit 40 includes a sensor unit 41 that irradiates light upon the upper object and detects reflection light reflected by and returning from the upper object, and a distance calculation circuit 42 that calculates the distance between the blade 100 and the upper object based on the detected reflection light. A first communication unit is an example of the upper face side distance detection unit 40.

The lower face side distance detection unit 50 measures the distance to a lower object existing below the blade 100. The lower face side distance detection unit 50 includes a sensor unit 51 that irradiates light upon the lower object and detects reflection light reflected by and returning from the lower object, and a distance calculation circuit 52 that calculates the distance between the blade 100 and the lower object based on the detected reflection light. A second communication unit is an example of the lower face side distance detection unit 50.

The upper face side communication unit 60 is hardware for communicating with another blade 100 mounted at a position above the blade 100. As communication tool, for example, infrared communication may be used. The upper face side communication unit 60 includes a communication module 61, a reception circuit 62, and a transmission circuit 63. The communication module 61 is an interface for communication with the blade 100 above the own blade 100. The reception circuit 62 is a circuit that is coupled to the communication module 61 and extracts data from a frame received from the upper blade 100. The reception circuit 62 is coupled to the communication module 61 and may decide a communication state of the communication module 61, more particularly, may decide whether or not the communication module 61 is in a state in which it is communicatable with a different apparatus. The transmission circuit 63 is a circuit that generates a frame to be transmitted to the upper blade 100.

The lower face side communication unit 70 is hardware for communicating with a blade 100 mounted at a position below the blade 100. As communication tool, for example, infrared communication may be used. The lower face side communication unit 70 includes a communication module 71, a reception circuit 72, and a transmission circuit 73. The communication module 71, the reception circuit 72, and the transmission circuit 73 have functions similar to the functions of the communication module 61, the reception circuit 62, and the transmission circuit 63 described above, respectively.

The signal processing unit 80 has a function for controlling transmission and reception of a signal such as a data signal or a control signal. For example, the signal processing unit 80 executes a process for specifying a port from which a signal outputs based on destination information extracted from a received signal and a routing table (not depicted) indicating a corresponding relationship between destinations and output ports.

The signal communication unit 90 is hardware for communicating with an external apparatus. The signal communication unit 90 receives a signal such as a data signal or a control signal from an external apparatus or a different blade 100 and transfers the received signal to the signal processing unit 80. Alternatively, the signal communication unit 90 receives a signal from the signal processing unit 80 and outputs the signal toward an external apparatus or a different blade 100 from a port designated by the signal processing unit 80. A first signal communication unit and a second signal communication unit are an example of the signal communication unit 90.

Now, a hardware configuration of the blade 100 is described.

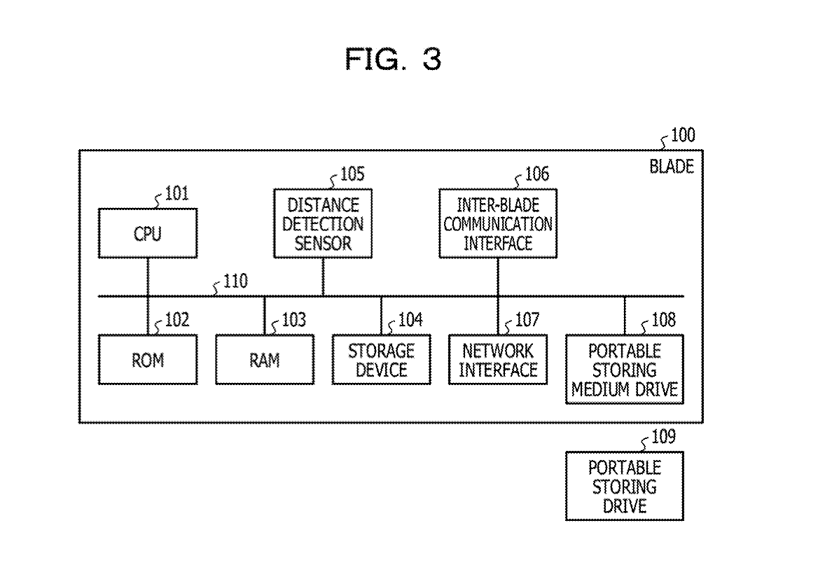

FIG. 3 is a view depicting an example of a hardware configuration of a blade. As depicted in FIG. 3, the blade 100 includes a central processing unit (CPU) 101, a read-only memory (ROM) 102, a random access memory (RAM) 103, a storage device 104, a distance detection sensor 105, an inter-blade communication interface 106, a network interface 107, a portable storing medium drive 108 and so forth.

The CPU 101 is hardware that manages or executes process of the blade 100. Also a micro processing unit (MPU) is an example of the CPU 101. The CPU 101 is an example of the position specification unit 30 and the signal processing unit 80.

The ROM 102, the RAM 103, and the storage device 104 are hardware for placing data and programs to be used for process executed by the CPU 101. The storage device 104 is, for example, a hard disc drive (HDD). The ROM 102 and the storage device 104 are an example of the first storage unit 10 depicted in FIG. 2. The RAM 103 is an example of the second storage unit 20 depicted in FIG. 2.

The inter-blade communication interface 106 is hardware for communicating with a different blade 100. The inter-blade communication interface 106 is an example of the upper face side communication unit 60 and the lower face side communication unit 70 depicted in FIG. 2.

The network interface 107 is hardware for communicating with an external apparatus through the network 125. The network interface 107 is an example of the signal communication unit 90 depicted in FIG. 2.

The respective components of the blade 100 are coupled to a bus 110. In the blade 100, programs (including the position specification program) stored in the ROM 102 or the storage device 104 or programs (including the position specification program) read from a portable storing medium 109 by the portable storing medium drive 108 are executed by a processor such as the CPU 101 to implement the functions of the blade 100. Such programs may be loaded into the RAM 103 and executed by a processor such as the CPU 101.

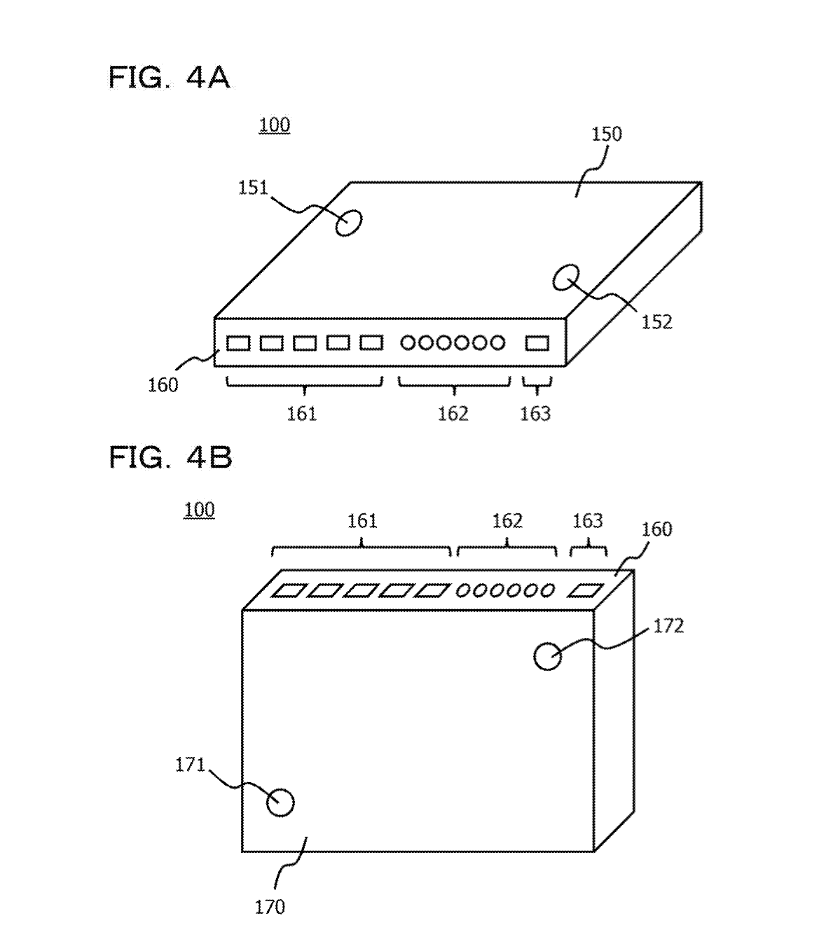

FIGS. 4A and 4B are views depicting examples of perspective views of a blade. FIG. 4A is a perspective view of an upper face of the blade 100. As depicted in FIG. 4A, a communication port 151 and a distance detection sensor 152 are provided on an upper face portion 150 of the blade 100. The communication port 151 is a form of the communication module 61 depicted in FIG. 2 and is part of the inter-blade communication interface 106 depicted in FIG. 3. Meanwhile, the distance detection sensor 152 is a form of the sensor unit 41 depicted in FIG. 2 and is part of the distance detection sensor 105 depicted in FIG. 3.

On a side face portion 160 neighboring with the upper face portion 150 of the blade 100, a data signal port group 161 including a plurality of ports, a state indication light emission diode (LED) group 162, and a control signal port 163 are provided. The data signal port group 161, the state indication LED group 162, and the control signal port 163 are part of the network interface 107 depicted in FIG. 3. The data signal port group 161 is a group of ports for transmitting and receiving a data signal. The control signal port 163 is a port for transmitting and receiving a control signal. Each LED of the state indication LED group 162 is used as an indicator that indicates whether or not a corresponding port of the data signal port group 161 or the control signal port 163 is coupled to a cable (not depicted) and it is in a state in which it is communicatable with a coupling destination by the cable. For example, lighting of any LED of the state indication LED group 162 indicates a state in which the corresponding port is communicatable with the coupling destination of the cable. On the other hand, non-lighting of any LED of the state indication LED group 162 indicates a state in which it is not communicatable with the coupling destination of the cable.

FIG. 4B is a perspective view of a lower face portion 170 of the blade 100. As depicted in FIG. 4B, on the lower face portion 170 neighboring with the side face portion 160 of the blade 100, a communication port 171 and a distance detection sensor 172 are provided. The communication port 171 is a form of the communication module 71 depicted in FIG. 2 and is part of the inter-blade communication interface 106 depicted in FIG. 3. Meanwhile, the distance detection sensor 172 is a form of the sensor unit 51 depicted in FIG. 2 and is part of the distance detection sensor 105 depicted in FIG. 3.

Now, a mounting position detection method executed by the transmission apparatus 115 depicted in FIG. 1 in the first embodiment is described.

The quantity, type, and mounting position of plural blades 100 mounted on the open rack 120 may not be always same and may be changed but not regularly. Therefore, in the present embodiment, each of the plurality of blades 100 mounted on the open rack 120 of the transmission apparatus 115 regularly executes a process for specifying a positional relationship with a different blade 100 in the open rack 120. For example, each of the plurality of blades 100 specifies the distance to a different blade 100 mounted next thereto. Then, the blade 100 executes a process for specifying to which one of a blade at the uppermost stage, a blade at the lowermost image, and an intermediate blade positioned between the blades at the uppermost and lowermost stages the own apparatus corresponds. The “different blade 100 mounted next thereto” described above is a blade 100 mounted such that it is opposed to the own apparatus in the open rack 120. Accordingly, in addition to a blade 100 mounted next to the own apparatus, the “different blade 100 mounted next thereto” includes a blade 100 mounted in a spaced relationship from the own apparatus.

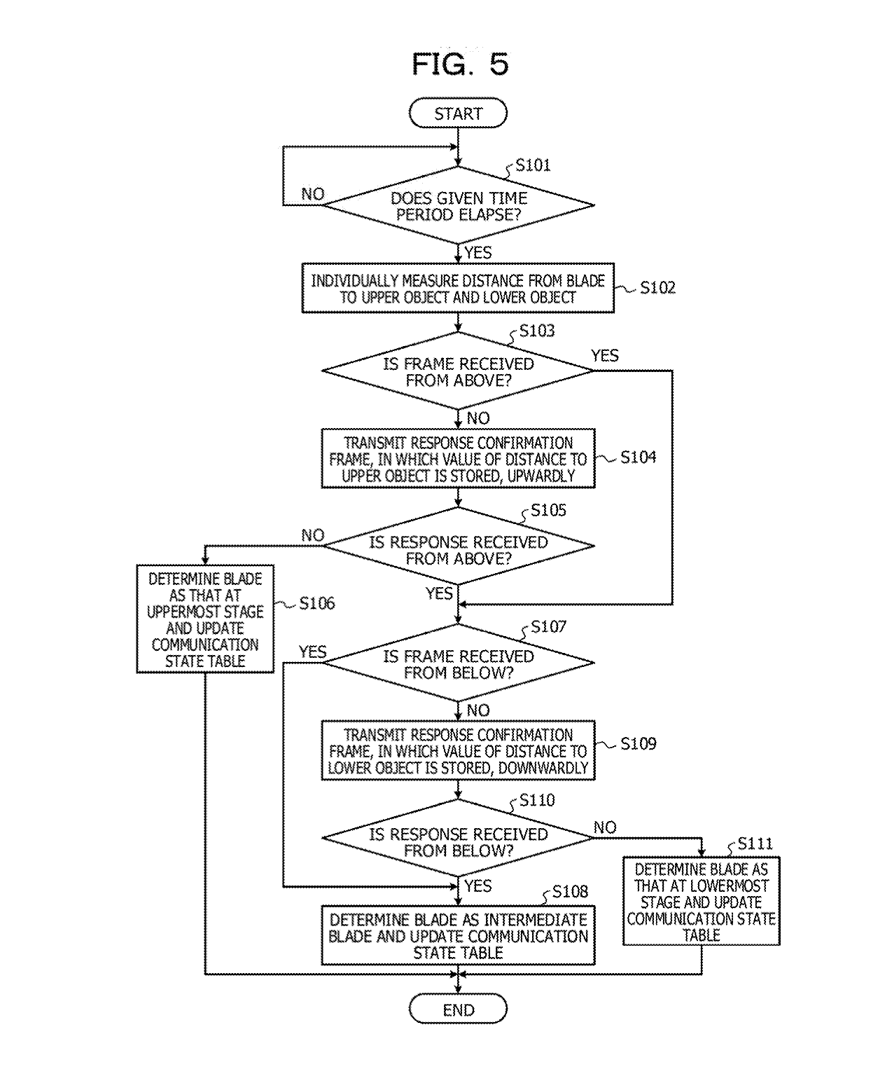

FIG. 5 is a flow chart illustrating a process for specifying a positional relationship with a different blade, which is executed by each of a plurality of blades in the first embodiment.

First, the position specification unit 30 of the blade 100 decides whether or not a given period of time elapses (S101). The given period of time is, for example, one hour. However, the given period of time may be set shorter than one hour based on a use situation of the transmission apparatus 115. If it is decided that the given period of time does not elapse (S101: No), the position specification unit 30 executes the process at S101 again. On the other hand, if it is decided that the given period of time elapses (S101: Yes), the upper face side distance detection unit 40 and the lower face side distance detection unit 50 measure the distance from the blade 100 to the upper object and the lower object, respectively (S102). Thereafter, the position specification unit 30 acquires values of the distances to the upper object and the lower object from the upper face side distance detection unit 40 and the lower face side distance detection unit 50, respectively, and places the acquired data into the distance information table 22 in the second storage unit 20.

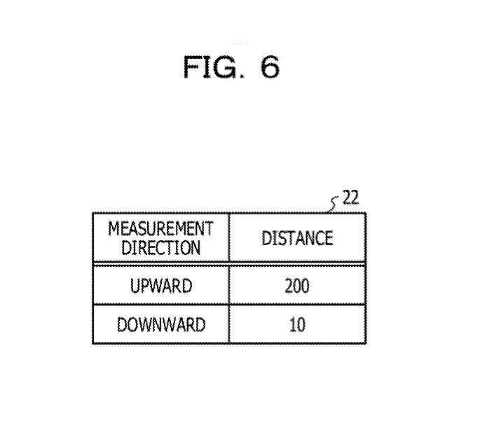

FIG. 6 is a view illustrating an example of a distance information table. The distance information table 22 has an item for the measurement direction and an item for the distance. Here, the “measurement direction” indicates a direction in which a target object that is the measurement target of the distance exists. In the item for the measurement direction, two directions of “upward” and “downward” are set in advance. In the example of FIG. 6, as a result of the process at S102, “200” is stored as a value of the distance to the upper object and “10” is stored as a value of the distance to the lower object, individually.

Referring back to FIG. 5, after S102, the position specification unit 30 decides whether or not a frame is received from above (S103). If it is decided that a frame is not received from above (S103: No), the position specification unit 30 transmits a response confirmation frame, in which the value of the distance to the upper object is stored, upwardly (S104).

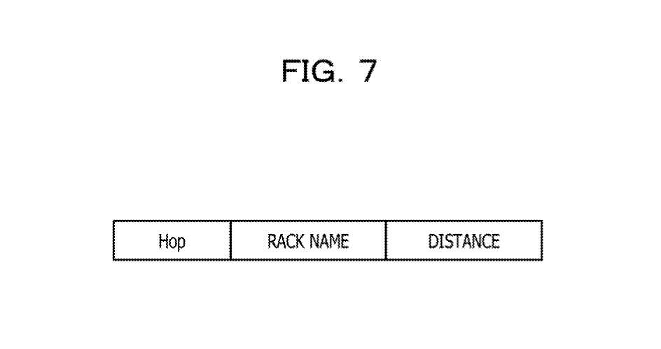

FIG. 7 is a view illustrating an example of a format of a response confirmation frame. As illustrated in FIG. 7, the response confirmation frame includes respective fields for “Hop,” “Rack name,” and “Distance.” “Hop” indicates a stage number of a destination blade where the blade 100 at the uppermost stage is represented as first stage. “Rack name” indicates information relating to a name of the open rack 120. “Distance” indicates a distance to the upper object or the lower object measured at S102. By the process at S104, into the “Hop” field of a response confirmation frame to be transmitted upwardly, information of “999” indicating an initial stage of a process for specifying a mounting position is stored. Into the “Rack” field, “Null” is stored. At S104, since a response confirmation frame is transmitted upwardly, into the “Distance” field, a value of the distance between the blade 100 and the upper object is stored.

Referring back to FIG. 5, after the process at S104, when a given waiting time period elapses, the position specification unit 30 decides whether or not a response to the response confirmation frame is received from above (S105). If it is decided that a response is not received from above (S105: No), since a different blade 100 does not exist above, the position specification unit 30 decides that the own apparatus is a blade 100 at the uppermost stage and updates the communication state table 21 (S106). Then, the position specification unit 30 ends the series of processes.

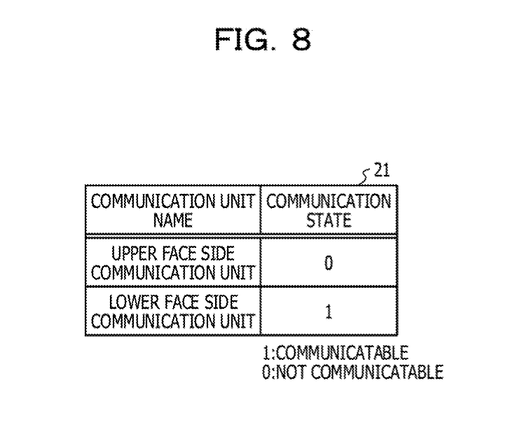

FIG. 8 is a view illustrating an example of a state of a communication state table at S105. The communication state table 21 has an item of “Communication unit name” and an item of “Communication state.” Here, in the item of “Communication unit name,” two communication units including “Upper face side communication unit” and “Lower face side communication unit” are set in advance. In the example of FIG. 8, since it is made clear as a result of the process at S105 that the own apparatus is a blade 100 at the uppermost stage, “0” that is a flag indicating that the blade 100 is not communicatable is stored in the item of “Upper face side communication unit.” Further, in the item of “Lower side face communication unit,” “1” that is a flag indicating that the blade 100 is communicatable is stored.

Referring back to FIG. 5, if it is decided at S103 that a frame is received from above (S103: Yes), since it has become clear that a different blade 100 exists above, the position specification unit 30 advances the process to S107 skipping the processes at S104 and S105 for transmitting a response confirmation frame upwardly and confirming presence or absence of a response. If it is decided at S105 that a response is received from above (S105: Yes), since it has become clear that a different blade 100 exists above, also in this case, the process advances to S107.

Then, after the distance to the upper object and the lower object is individually measured at S102, the position specification unit 30 decides whether or not a frame is received from below (S107). If it is decided that a frame is received from below (S107: Yes), since it has become clear that a different blade 100 exists above and below, the position specification unit 30 decides that the own apparatus is an intermediate blade and updates the communication state table 21 (S108). Then, the series of processes is ended.

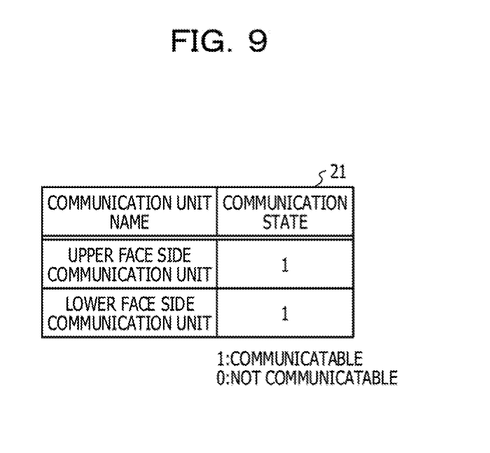

FIG. 9 is a view illustrating an example of a state of a communication state table. In the example of FIG. 9, since it has become clear as a result of the process at S107 that a different blade 100 exists above and below, “1” that is a flag indicating that the blade 100 is communicatable is stored into the items of “Upper face side communication unit” and “Lower face side communication unit.”

On the other hand, if it is decided at S107 that a frame is not received from below (S107: No), the position specification unit 30 transmits a response confirmation frame, in which the value of the distance to the lower objet is stored, downwardly (S109). Since the response confirmation frame is transmitted downwardly at S109, the value of the distance to the lower object is stored into the field of “Distance” of the format of the response confirmation frame illustrated in FIG. 7.

Then, the position specification unit 30 decides whether or not a response to the response confirmation frame is received from below (S110). If it is decided that a response is not received from below (S110: No), since a different blade 100 does not exist below, the position specification unit 30 decides that the own apparatus is a blade 100 at the lowermost stage and updates the communication state table 21 (S111). Then, the series of processes is ended.

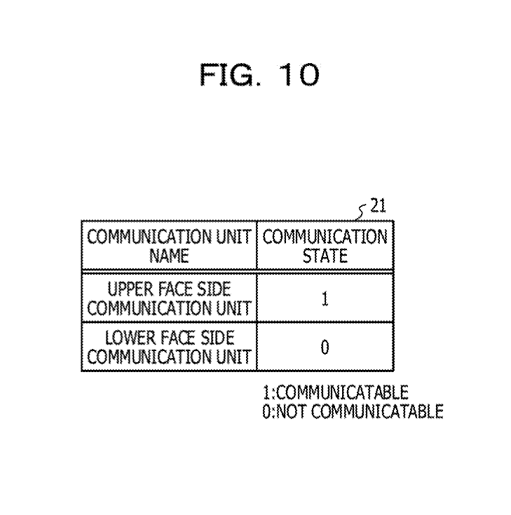

FIG. 10 is a view illustrating an example of a state of a communication state table at S111. In the example of FIG. 10, since it has become clear as a result of the process at S111 that the own apparatus is the lowermost stage blade, “1” that is a flag that indicates that the blade 100 is communicatable is stored into the item of “Upper face side communication unit.” Then, into the item of “Lower face side communication unit,” “0” that is a flag indicating that the blade 100 is not communicatable is stored.

Referring back to FIG. 5, if it is decided at S110 that a response is received from below (S110: Yes), since it has become clear that a different blade 100 exists above and below, the position specification unit 30 decides that the own apparatus is an intermediate blade and updates the communication state table 21 (S108). Then, the series of processes is ended. The state of the communication state table 21 after the updating is similar to the state illustrated in FIG. 9.

The series of processes for specifying a positional relationship with a different blade 100 is executed in such a manner as described above.

Now, a particular example of a process for specifying a positional relationship with a different blade 100, which is executed by each of the plurality of blades 100, is described with reference to the flow chart of FIG. 5 using a sequence diagram.

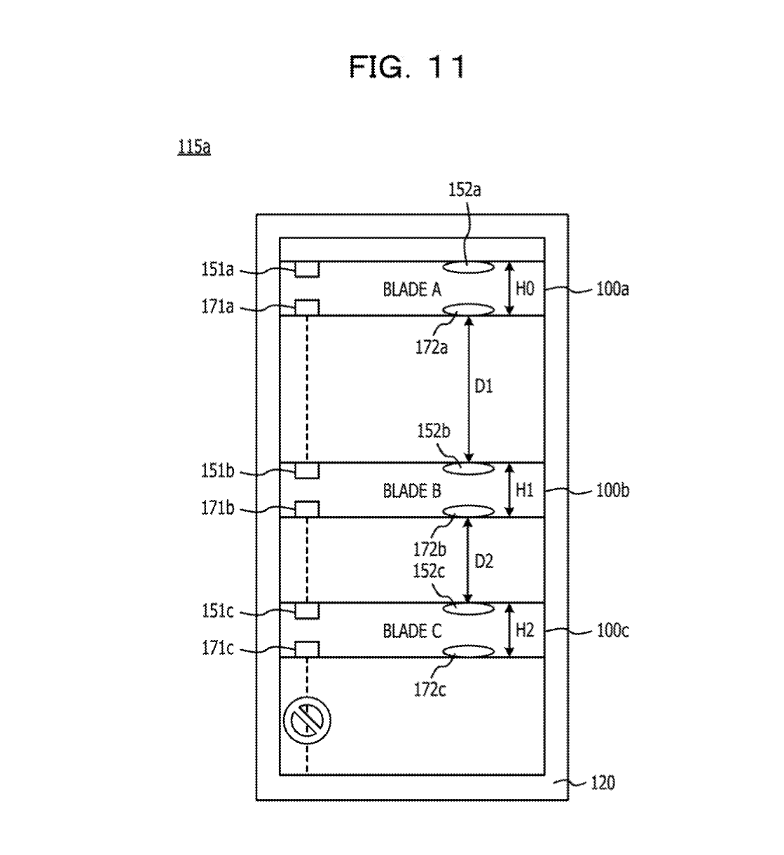

FIG. 11 is a view depicting an example of disposition of a plurality of blades in a transmission apparatus in the first embodiment. As depicted in FIG. 11, the transmission apparatus 115a includes an open rack 120, and a blade A 100a, another blade B 100b, and a further blade C 100c provided in the open rack 120.

The blade A 100a corresponds to a blade 100 at the uppermost stage, and the height of the apparatus is indicated by H0. The blade A 100a includes a communication port 151a and a distance detection sensor 152a provided on the upper face side thereof and includes a communication port 171a and a distance detection sensor 172a provided on the lower face side thereof.

The blade B 100b is an intermediate blade, and the height of the apparatus is represented by H1. The blade B 100b includes communication port 151b and a distance detection sensor 152b provided on the upper face side thereof and a communication port 171b and a distance detection sensor 172b provided on the lower face side thereof.

The blade C 100c corresponds to a blade 100 at the lowermost stage, and the height of the apparatus is represented by H2. The blade C 100c includes a communication port 151c and a distance detection sensor 152c provided on the upper face side thereof and a communication port 171c and a distance detection sensor 172c provided on the lower face side thereof.

The interval between the blade A 100a and the blade B 100b, for example, the distance between the lower face of the blade A 100a and the upper face of the blade B 100b, is D1. The interval between the blade B 100b and the blade C 100c, for example, the distance between the lower face of the blade B 100b and the upper face of the blade C 100c, is D2.

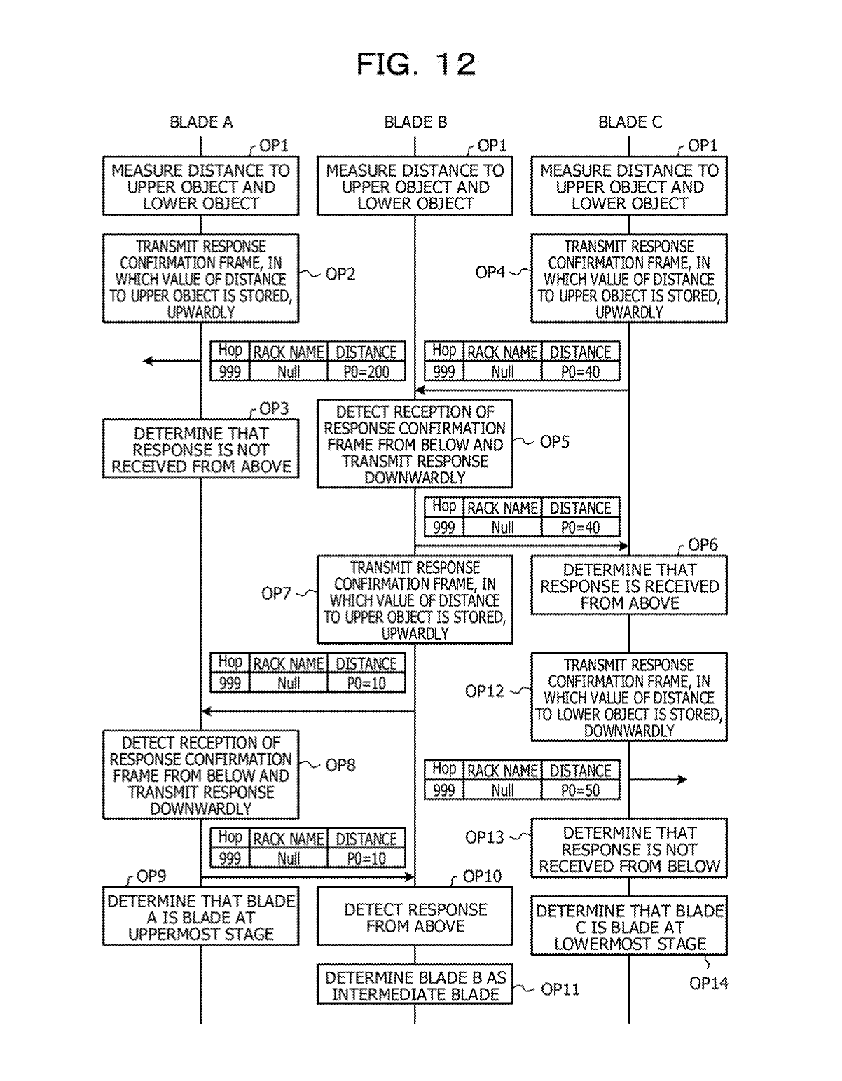

FIG. 12 is an example of a sequence diagram of a process for specifying a positional relationship with a different blade, which is executed by each of a plurality of blades in the first embodiment.

Each of the blade A 100a, the blade B 100b, and the blade C 100c measures, if it is decided at S101 that the given period of time elapses, the distance to the upper object and the lower object at S102 (OP1). Then, if it is decided that a frame is not received from above at S103, the blade A 100a upwardly transmits a response confirmation frame in which the value of the distance to the upper object is stored at S104 (OP2). In the field of the “Hop” field of the response confirmation frame transmitted from the blade A 100a, “999” is stored. In the “Rack name” field, “Null” is stored. In the “Distance” field, information of “P0=200” indicating the distance between the upper face of the blade A 100a and the upper object is stored.

Since the blade A 100a does not receive a response to the response confirmation frame from above even after the given waiting time period elapses, it decides that it does not receive a response from above at S105 (OP3). Then, the process advances to S106.

If it is decided at S103 that a frame is not received from above after the OP1, the blade C 100c transmits, at S104, a response confirmation frame, in which the value of the distance to the upper object is stored, upwardly, for example, toward the blade B 100b (OP4). “999” is stored in the “Hop” field of the response confirmation frame transmitted from the blade C 100c. In the “Rack name” field, “Null” is stored. In the “Distance” field, information of “P0=40” indicating the distance between the upper face of the blade C 100c and the upper object, for example, the distance to the lower face of the blade B 100b, is stored.

Before the process at S103 is started, the blade B 100b detects reception of a response confirmation frame from below, for example, from the blade C 100c, and transmits the response downwardly (OP5). This response has information same as that of the response confirmation frame received from the blade C 100c.

The blade C 100c receives the response from the blade B 100b and decides at S105 that it receives a response from above (OP6). Then, the process advances to S107.

The blade B 100b decides at S103 that it does not receive a frame from above and transmits, at S104, a response confirmation frame, in which the value of the distance to the upper object, upwardly, for example, toward the blade A 100a (OP7). In the “Hop” field of the response confirmation frame transmitted from the blade B 100b, “999” is stored. In the “Rack name” field, “Null” is stored. In the “Distance” field, information of “P0=10” indicating the distance between the upper face of the blade B 100b and the upper object, for example, the distance to the lower face of the blade A 100a, is stored.

Before the blade A 100a starts the process at S106, it detects reception of a response confirmation frame from below, for example, from the blade B 100b, and transmits a response downwardly (OP8). This response has information same as that of the response confirmation frame received from the blade B 100b. Thereafter, at S106, the blade A 100a decides that the own apparatus is the blade 100 at the uppermost stage and updates the communication state table 21 (OP9).

The blade B 100b detects the response from the blade A 100a (OP10) and decides at S105 that a response is received from above. Then, the blade B 100b decides, based on the fact that a response confirmation frame is received from the blade C 100c by the OP5, that a frame is received from below at S107. Then, the process advances to S108. At S108, the blade B 100b decides that the own apparatus is an intermediate blade and updates the communication state table 21 (OP11).

Since the blade C 100c does not receive a frame from below, it decides at S107 that a frame is not received from below. Then, the blade C 100c transmits a response confirmation frame, in which the value of the distance to the lower object is stored at S109, downwardly (OP12). In the “Hop” field of the response confirmation frame transmitted from the blade C 100c, “999” is stored. In the “Rack name” field, “Null” is stored. In the “Distance” field, information of “P0=50” indicating the distance between the lower face of the blade C 100c and the lower object is stored.

Since the blade C 100c does not receive a response to the response confirmation frame from below even after the given waiting time period elapses, it decides at S110 that a response is not received from below (OP13). Then, the process advances to S111. At S111, the blade C 100c decides that the own apparatus is a blade 100 at the lowermost stage and updates the communication state table 21 (OP14).

The series of processes for specifying a positional relationship with a different blade 100, which is executed by each of the plurality of blades 100, is executed in such a manner as described above.

After the above-mentioned series of processes is executed, the transmission apparatus 115 executes a process for specifying a mounting position of each of the plurality of blades 100. In the following, a process executed by each of the plurality of blades 100 when a blade 100 at the uppermost stage is set as a reference blade is described.

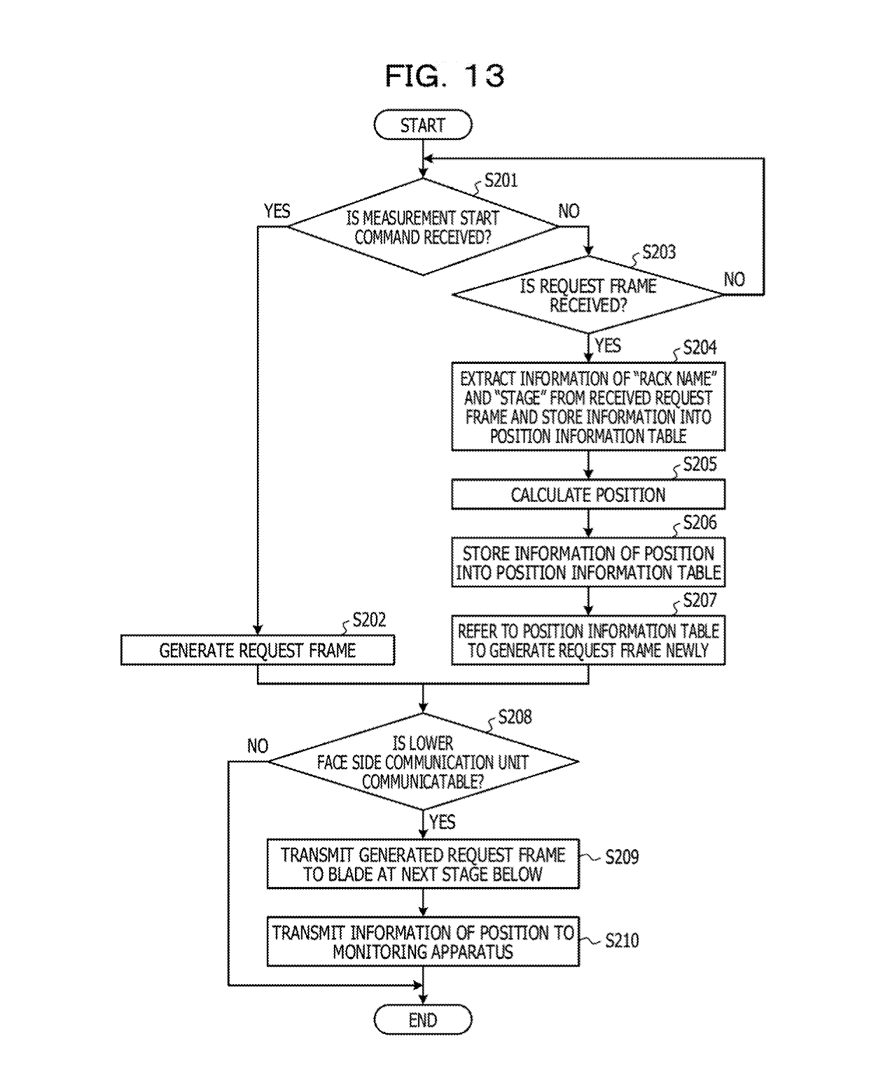

FIG. 13 is a flow chart illustrating a process for specifying a mounting position in an open rack, which is executed by each of a plurality of blades in the first embodiment. Here, description is given assuming that a target blade in the plurality of blades 100 executes the process.

First, the position specification unit 30 of the target blade decides whether or not it receives a measurement start command from the monitoring apparatus 130 (S201). If it is decided that a measurement start command is received (S201: Yes), the position specification unit 30 generates a request frame (S202). This request frame is a frame at an initial stage for requesting for specification of a mounting position.

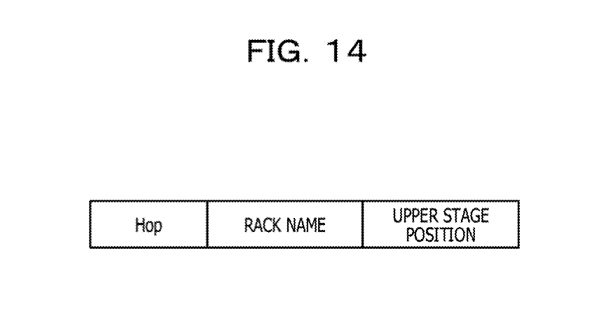

FIG. 14 is a view illustrating an example of a format of a request frame. As illustrated in FIG. 14, the request frame has respective fields for “Hop,” “Rack name,” and “Upper stage position.” “Hop” indicates a stage number of a destination blade where a blade 100 at the uppermost stage is defined as 0th stage blade. When a request frame is received, each blade 100 may grasp to which stage the own apparatus belongs by referring to the value of “Hop.” “Rack name” indicates information relating to a name of the open rack 120. “Upper stage position” indicates a relative distance to the lower face of a preceding stage blade above, which is a transmission source of the request frame, when the position of the lower face of the reference blade at the uppermost stage is determined as a start point.

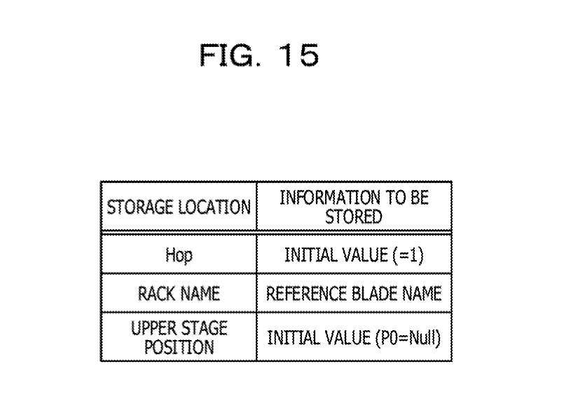

FIG. 15 is a view illustrating an example of data stored in respective fields of a request frame at an initial stage at S202. Since the request frame at the initial stage is generated by the reference blade at the uppermost stage, information of “1” indicating that the destination blade is a blade at the first stage is stored in the “Hop” field of the request frame. In the “Rack name” field, the reference blade name is stored. For example, where the transmission apparatus 115 has such a blade configuration as depicted in FIG. 11, in the “Rack name” field, “A” indicating that the blade is the blade A is stored. Since the reference blade and the transmission source of the request frame at the initial stage are same as each other, information of “Null” indicating that the value of the relative distance P0 described hereinabove stored in the “Upper stage position” field is zero is stored. Referring back to FIG. 13, after the process at S202, the process advances to S208. Processes at the steps beginning with step S208 are hereinafter described.

On the other hand, if it is decided at S201 that a measurement start command is not received (S201: No), the position specification unit 30 decides whether or not a request frame is received (S203). If it is decided that a request frame is not received (S203: No), the process returns to S201 such that the processes at the steps beginning with step S201 are executed again. On the other hand, if it is decided that a request frame is received (S203: Yes), the position specification unit 30 extracts information of “Rack name” and “Stage” from the received request frame and places the information into the position information table 23 (S204).

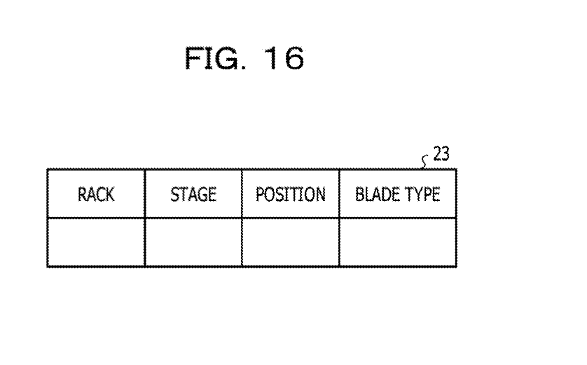

FIG. 16 is a view illustrating an example of a format of a position information table. The position information table is a table owned by each of the plurality of blades 100 mounted on the open rack 120. As illustrated in FIG. 16, the position information table 23 has items for “Rack,” “Stage,” “Position,” and “Blade type.” “Rack” indicates in which rack the blade 100 is installed. “Stage” indicates a stage number of a target blade when the reference blade is set to that of the 0th stage. “Position” indicates a relative distance to the lower face of the target blade when the position of the lower face of the reference blade is determined as a start point. “Blade type” indicates a name of the blade 100 in which the position information table is stored.

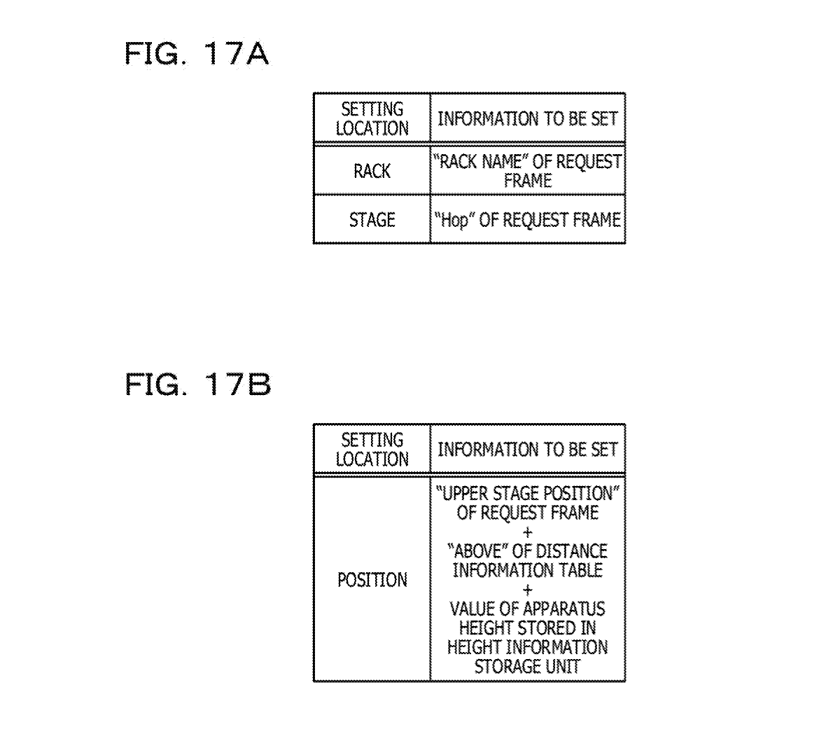

FIGS. 17A and 17B are views illustrating data stored into a position information table. FIG. 17A is a view illustrating information stored in the position information table 23 at S204. As depicted in FIG. 17A, in the item of “Rack” of the position information table 23, data stored in the “Rack name” field of the request frame is stored. In the item of “Stage” of the position information table 23, data stored in the “Hop” field of the request frame is stored.

Referring back to FIG. 13, after the process at S204, the position specification unit 30 calculates the position of the target blade with respect to the reference blade by using the information stored in the request frame (S205). At S205, the position specification unit 30 first extracts a value Pₓ stored in the “Upper stage position” field of the request frame. The value Pₓ indicates the position of the preceding stage blade positioned above with respect to the reference blade. Further, the position specification unit 30 extracts the distance Dₓ₊₁ between the target blade and the upper object measured upon the process at S102 of FIG. 5 by the target blade from the item of “Above” of the distance information table 22. Where the blade 100 at the uppermost stage is set as a reference blade, since the request frame is received by one of the intermediate blade and the lowermost stage blade, the upper object is the preceding stage blade on the upper side. For example, Dₓ₊₁ indicates the distance between the target blade and the preceding stage blade positioned above. Further, the position specification unit 30 extracts a value Hₓ₊₁ of the apparatus height of the target blade from the height information placement unit 11.

Thereafter, the position specification unit 30 calculates the distance Pₓ₊₁ between the lower face of the reference blade and the lower face of the target blade using the following expression (1). The value of Pₓ₊₁ indicates the position of the target blade with respect to the reference blade.

Pₓ₊₁=P_{c}+Dₓ₊₁+Hₓ₊₁ Expression (1):

The position of the target blade with respect to the reference blade is calculated in such a manner as described above. After the process at S205, the position specification unit 30 places the information of the calculated position into the position information table 23 (S206).

FIG. 17B is a view illustrating information stored into the position information table 23 at S206. As illustrated in FIG. 17B, in an item of “Position” of the position information table 23, a value of the sum of data stored in the “Upper stage position” field of the request frame, data stored in the item of “Above” of the distance information table 22, and data of the apparatus height of the target blade stored in the height information placement unit 11 is stored. The sum value indicates the position of the target blade.

Referring back to FIG. 13, after the process at S206, the position specification unit 30 refers to the position information table 23 to generate a request frame newly (S207).

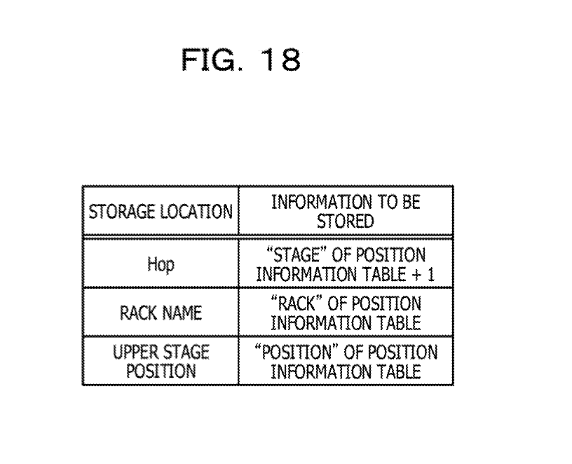

FIG. 18 is a view illustrating an example of data stored into a request frame to be generated newly at S207. In the “Hop” field of the request frame, a value obtained by adding 1 to the value stored in the item of “Stage” of the position information table 23 is stored. In the “Rack name” field, information stored in the item of “Rack” of the position information table 23 is stored. In the “Upper stage position” field, information stored in the item of “Position” of the position information table 23 is stored.

Referring back to FIG. 13, after the process at S202 or S207, the position specification unit 30 decides whether or not the lower face side communication unit 70 is communicatable (S208). At S208, the position specification unit 30 refers to a flag corresponding to the “Lower face side communication unit” stored in the communication state table 21 to decide whether or not the lower face side communication unit 70 is communicatable. If the flag is “1,” it is decided that the lower face side communication unit 70 is communicatable. On the other hand, if the flag is “0,” it is decided that the lower face side communication unit 70 is not communicatable. If it is decided at S208 that the lower face side communication unit 70 is not communicatable (S208: No), the series of processes is ended. On the other hand, if it is decided that the lower face side communication unit 70 is communicatable (S208: Yes), the position specification unit 30 transmits the generated request frame to the blade 100 at the next stage below (S209).

Then, the signal communication unit 90 transmits the information of the position calculated at S205 to the monitoring apparatus 130 through the network 125 (S210). The series of processes is ended thereby.

After all of the blades 100 in the open rack 120 execute the process illustrated in FIG. 13, the position information tables 23 of the plurality of blades 100 have stored therein information of the individual mounting positions in the open rack. Further, the monitoring apparatus 130 has received the information of the mounting position from all of the blades 100.

The series of processes for specifying a mounting position is executed in such a manner as described above.

Thereafter, the monitoring apparatus 130 having received the information of the mounting position of all of the plurality of blades 100 displays the received information on the screen of the display device 135. Consequently, the user of the monitoring apparatus 130 may recognize the mounting position of each blade 100 in the open rack 120.

Now, a particular example of a process for specifying a mounting position, which is executed by each of the plurality of blades 100 disposed in such a manner as depicted in FIG. 11 is described with reference to the flow chart of FIG. 13 using a sequence diagram.

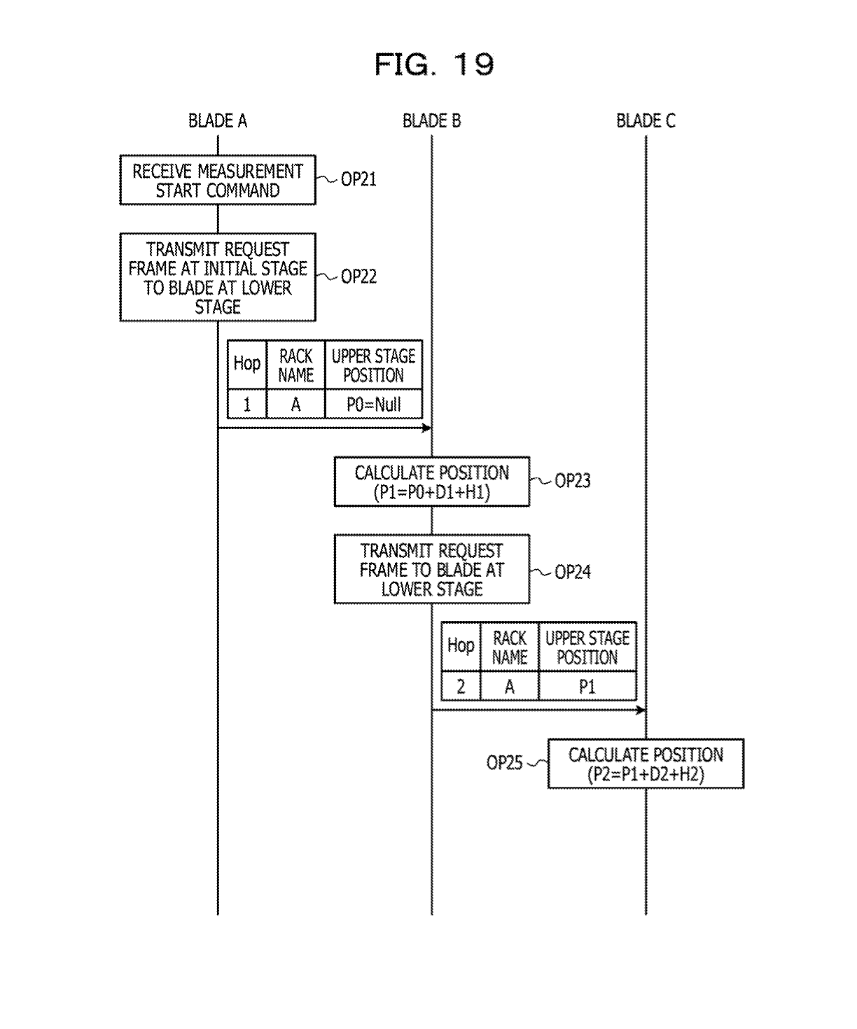

FIG. 19 is an example of a sequence diagram of a process for specifying a mounting position, which is executed by each of a plurality of blades in the first embodiment.

First, it is decided at S201 that the blade A 100a set as the reference blade receives a measurement start command (OP21). Then, the blade A 100a generates a request frame at an initial stage at S202 and transmits the initial request frame to the blade B 100b at the lower stage (OP22). In the “Hop” field of the request frame at the initial stage transmitted from the blade A 100a, “1” indicating that the blade A is at the first stage is stored. In the “Rack name” field, “A” indicating the name of the open rack 120 is stored. In the “Upper stage position” field, information of “P0=Null” indicating that the distance between the lower face of the reference blade and the lower face of the blade A 100a is zero is stored. After the OP22, the blade A transmits the position information of the blade A to the monitoring apparatus 130 at S210.

After it is decided at S201 that a measurement start command is not received, since the blade B 100b receives the request frame at the initial stage transmitted from the blade A 100a, it is decided at S203 that a request frame is received. Then, the blade B 100b extracts the information of “Rack name” and “Stage” from the request frame received at S204 and places the information into the position information table 23, whereafter it calculates the position of the blade B 100b at S205 (OP23). In the OP23, the position specification unit 30 extracts the relative distance P0 from the request frame and extracts the distance D1 between the blade B 100b and the upper object from the distance information table 22. Further, the position specification unit 30 extracts the value H1 of the apparatus height of the blade B 100b from the height information placement unit 11. Thereafter, at S205, the position specification unit 30 calculates the distance P1 between the lower face of the blade A 100a and the lower face of the blade B 100b in accordance with the following expression (2).

P1=P0+D1+H1 Expression (2):

The blade B 100b places the information of P1 calculated at S206 into the position information table 23 and generates a request frame newly at S207. Then at S208, it is decided that the lower face side communication unit is communicatable, and the blade B 100b transmits the generated request frame to the blade C 100c at the lower stage (OP24). In the “Hop” field of the request frame transmitted from the blade B 100b, “2” indicating that the blade B is at the second stage is stored. In the “Rack name” field, “A” indicating the name of the open rack 120 is stored. In the “Upper stage position” field, the value of the distance P1 between the lower face of the blade A 100a and the lower face of the blade B 100b is stored. After the OP24, the blade B transmits the position information of the blade B to the monitoring apparatus 130 at S210.

After it is decided at S201 that a measurement start command is not received, since the blade C 100c receives the request frame transmitted from the blade B 100b, it is decided at S203 that a request frame is received. Then, the blade C 100c extracts information of “Rack name” and “Stage” from the request frame received at S204 and places the information into the position information table 23, whereafter it calculates the position of the blade C 100c itself at S205 (OP25). In the OP25, the position specification unit 30 extracts P1 from the request frame and extracts the distance D2 between the blade C 100c and the upper object from the distance information table 22. Further, the position specification unit 30 extracts the value H2 of the apparatus height of the blade C 100c from the height information placement unit 11. Thereafter, at S205, the position specification unit 30 calculates the distance P2 between the lower face of the blade B 100b and the lower face of the blade C 100c in accordance with the expression (3) given below:

P2=P1+D2+H2 Expression (3):

The blade C 100c places the information of the distance P2 calculated at S206 into the position information table 23 and generates a request frame newly at S207. Then at S208, it is decided that the lower face side communication unit is not communicatable, and the process advances to S210. At S210, the blade C transmits the position information of the blade C to the monitoring apparatus 130. The process is ended thereby.

The process for specifying a mounting position of each of the plurality of blades 100 depicted in FIG. 11 is executed in such a manner as described above.

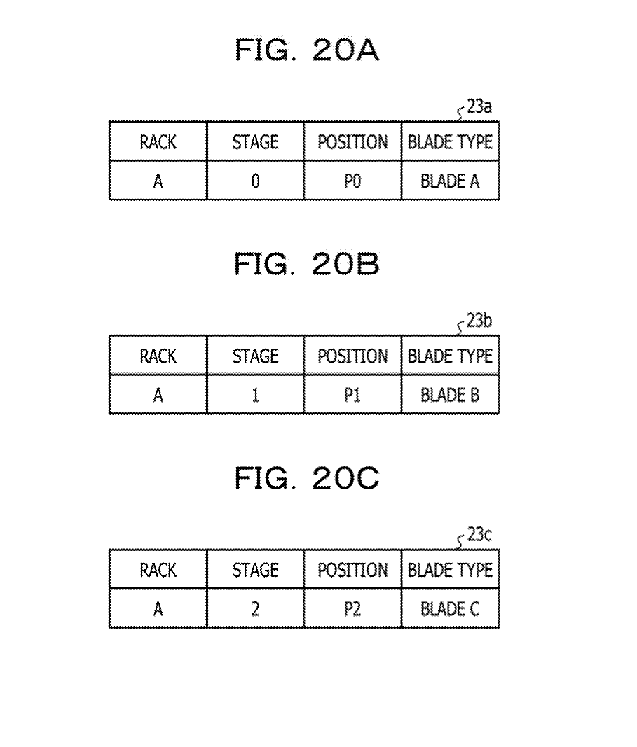

FIGS. 20A, 20B, and 20C are views illustrating examples of position information tables stored individually in the plurality of blades depicted in FIG. 11. FIG. 20A is a view depicting a position information table 23a stored in the blade A. FIG. 20B is a view illustrating a position information table 23b stored in the blade B. FIG. 20C is a view illustrating a position information table 23c stored in the blade C.

As depicted in FIG. 20A, in the item of “Rack” of the position information table 23a of the blade A, information of “A” indicating that the rack name is A is stored. In the item of “Stage,” information of “0” indicating that the blade A is a reference blade is stored. In the item of “Position,” information of “P0” is stored. In the item of “Blade type,” information of the “Blade A” indicating that the type of the blade is the blade A is stored.

As depicted in FIG. 20B, in the item of “Rack” of the position information table 23b of the blade B, information of “A” indicating that the rack name is A is stored. In the item of “Stage,” information of “1” indicating that the blade B is at the first stage from the reference blade is stored. In the item of “Position,” information of “P1” indicating a relative distance of the blade B to the blade A is stored. In the item of “Blade type,” information of the “Blade B” indicating that the type of the blade is the blade B is stored.

As depicted in FIG. 20C, in the item of “Rack” of the position information table 23c of the blade C, information of “A” indicating that the rack name is A is stored. In the item of “Stage,” information of “2” indicating that the blade C is at the second stage from the reference blade is stored. In the item of “Position,” information of “P2” indicating a relative distance of the blade C to the blade A is stored. In the item of “Blade type,” information of the “Blade C” indicating that the type of the blade is the blade C is stored.

In this manner, by executing the processes of the first embodiment, each blade in the open rack may grasp a mounting position thereof with respect to the blade A that is a reference blade.

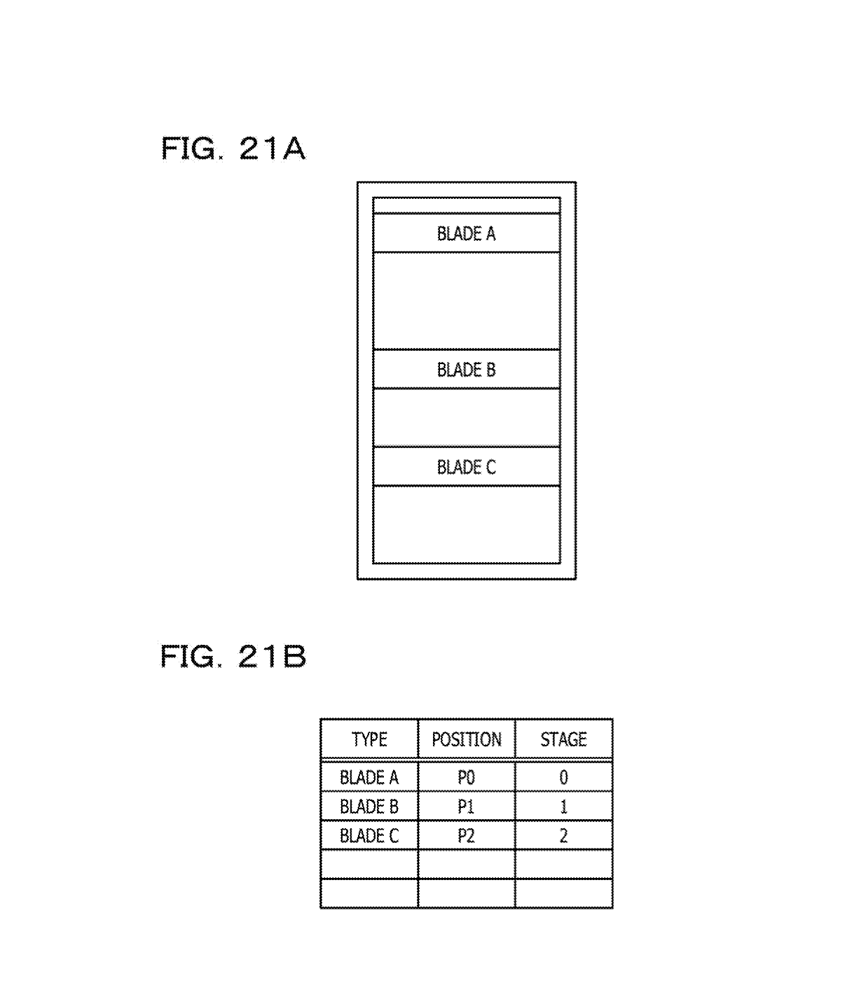

FIGS. 21A and 21B are views illustrating examples of information displayed on a screen of a display device. FIG. 21A illustrates an example in which a configuration diagram depicting a positional relationship between the open rack 120 and the respective blades 100 is displayed. The monitoring apparatus 130 generates a configuration diagram based on numerical value information of the mounting positions acquired from all of the blades 100 in the open rack 120. Then, the monitoring apparatus 130 displays the generated configuration diagram on the screen of the display device 135. By the processes described hereinabove, the display device 135 may display such a configuration diagram as depicted in FIG. 21A. An operator who performs a maintenance work may carry, if the monitoring apparatus 130 is a terminal apparatus of the portable type, the terminal apparatus to a place at which the transmission apparatus 115 is installed and perform a maintenance work using the image displayed on the screen. Alternatively, also it is possible to print the configuration diagram displayed on the screen of the display device 135 on a medium such as paper and use the configuration diagram at the place at which the transmission apparatus 115 is installed.

If an operator who performs a maintenance work performs a work for specifying a blade 100 of a maintenance target by visual inspection, as the number of blades 100 to be mounted increases, the time period to specify the blade 100 of the maintenance target increases and also the possibility of misrecognition increases. On the other hand, according to such a configuration diagram as depicted in FIG. 21A, which is generated based on numerical value information of a mounting position, since the mounting position of the blades 100 may be grasped visually, the time period to specify the blade 100 of the maintenance target decreases and also the misrecognition of the blade 100 becomes less likely to occur. Consequently, degradation of the maintainability may be suppressed.

FIG. 21B illustrates an example in which numerical value information of the mounting position for each blade 100 is displayed in the form of a table. This table includes items for the type, position, and stage number of the blades 100. The user of the monitoring apparatus 130 may freely select a display form based on the quantity of blades 100, a situation of a maintenance work and so forth. The configuration diagram of FIG. 21A and the data table of FIG. 21B may be displayed simultaneously.

According to the first embodiment, each blade 100 measures interval to a different blade 100 mounted next, receives first position information indicating a relative position of the different blade 100 with respect to a reference blade, and calculates second position information indicating a relative position of the own apparatus with respect to the reference blade based on the measured interval and the first position information. According to this method, since each blade in the open rack 120 may successively acquire information to be used for calculation of a mounting position of the own apparatus from other blades 100 mounted next, also where the open rack 120 is used, the mounting position of each of a plurality of blades 100 in the open rack 120 may be specified.

### Second Embodiment

Now, a second embodiment is described. In the first embodiment, each blade 100 in the open rack 120 acquires information of a mounting position of the blades 100 and places the information into the position information table 23 the blade 100 has. In contrast, in the second embodiment, a reference blade is characterized by collecting information of a mounting position from each blade 100 in the open rack 120.

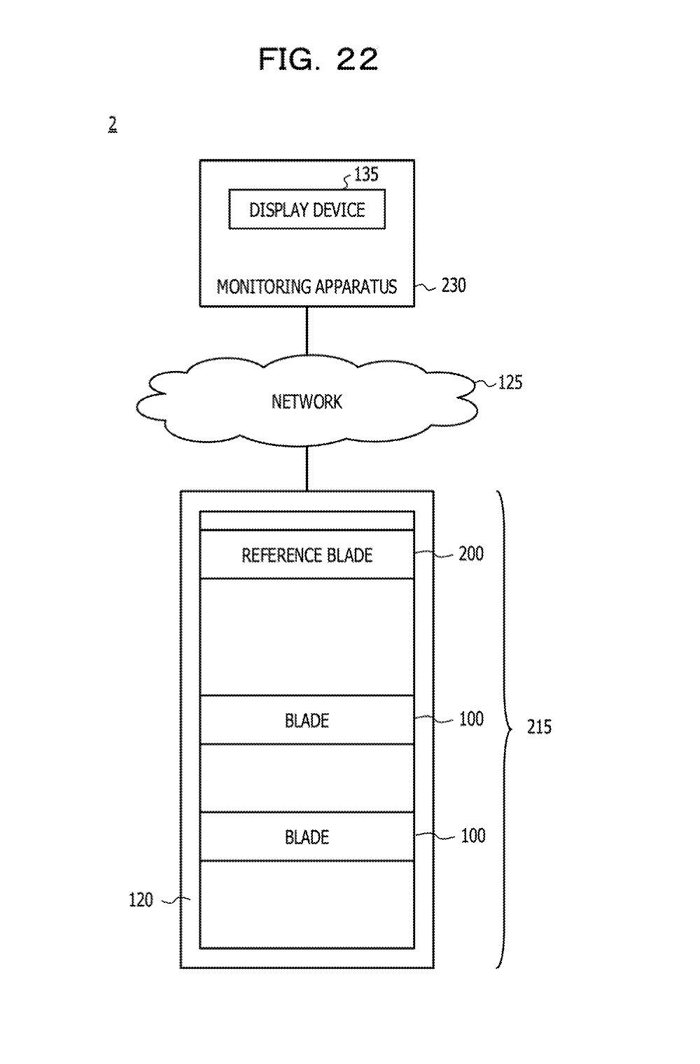

In the following, the second embodiment is described with reference to FIGS. 22 to 42. The hardware configuration view of each blade 100 in the second embodiment is similar to the hardware configuration view of each blade 100 in the first embodiment depicted in FIG. 3, and therefore, description of the blade 100 is omitted herein. In the following, an embodiment in which a blade 100 at the uppermost stage is set as a reference blade is described. A process for specifying a positional relationship with a different blade 100, which is executed by each of a plurality of blades 100, is similar to the process in the first embodiment, and therefore, description of the process is omitted herein.

FIG. 22 is a view depicting an example of a system in the second embodiment. The same components to those in the first embodiment are denoted by the same reference symbols to those in the first embodiment, and description of them is omitted herein. As depicted in FIG. 22, a system 2 includes a transmission apparatus 215 and a monitoring apparatus 230. The transmission apparatus 215 and the monitoring apparatus 230 are coupled to each other by a network 125 such that they may communicate with each other.

The transmission apparatus 215 includes an open rack 120, a reference blade 200, and a plurality of blades 100 that are not set as a reference blade. The reference blade 200 and the plurality of blades 100 are mounted in such a manner as to be accommodated in the open rack 120.

The monitoring apparatus 230 is an apparatus that includes a display device 135 and monitors the transmission apparatus 215. The monitoring apparatus 230 transmits a measurement start command to the reference blade 200 at the uppermost stage such that it acquires information of a mounting position of the reference blade 200 and the plurality of blades 100 in the open rack 120 from the reference blade 200. Then, the monitoring apparatus 230 displays the acquired information on the screen of the display device 135. Consequently, the user of the monitoring apparatus 230 may recognize a blade configuration of the transmission apparatus 215.

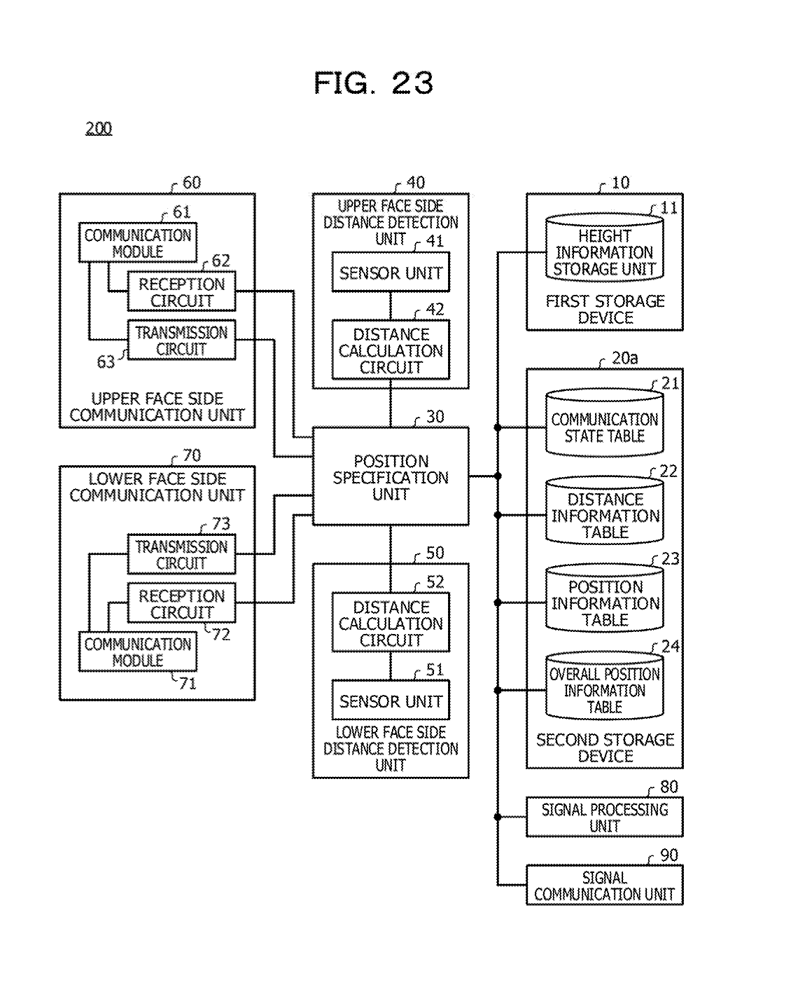

FIG. 23 is a functional block diagram of a reference blade in the second embodiment. The same functional blocks to those in the first embodiment are denoted by the same reference symbols to those in the first embodiment, and description of them is omitted herein. As depicted in FIG. 23, the reference blade 200 includes an overall position information table 24 in a second storage unit 20a. The overall position information table 24 is a table in which data of the position information tables 23 individually provided in the plurality of blades 100 in the open rack 120 are aggregated. A second placement unit is an example of the overall position information table 24.

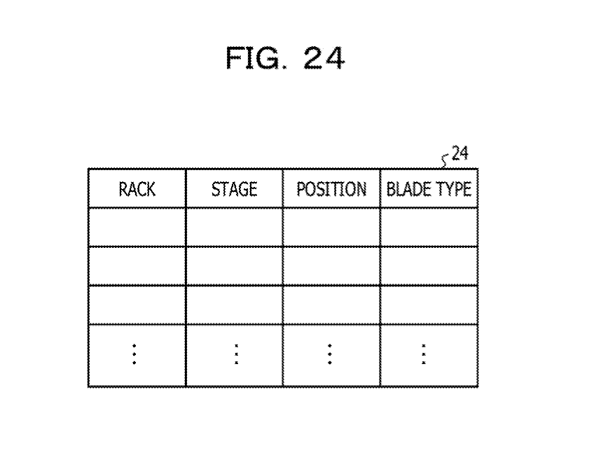

FIG. 24 is a view illustrating an example of an overall position information table. As illustrated in FIG. 24, the overall position information table 24 has respective items for “Rack,” “Stage,” “Position,” and “Blade type” similar to those in the position information table 23. By using a value stored in the item for “Stage” as an index value, the position specification unit 30 may refer to position information of a blade 100 at a corresponding stage. The functional blocks of the plurality of blades 100 other than the reference blade 200 are same as the functional blocks in the first embodiment.

First, a process executed by the reference blade 200 is described.

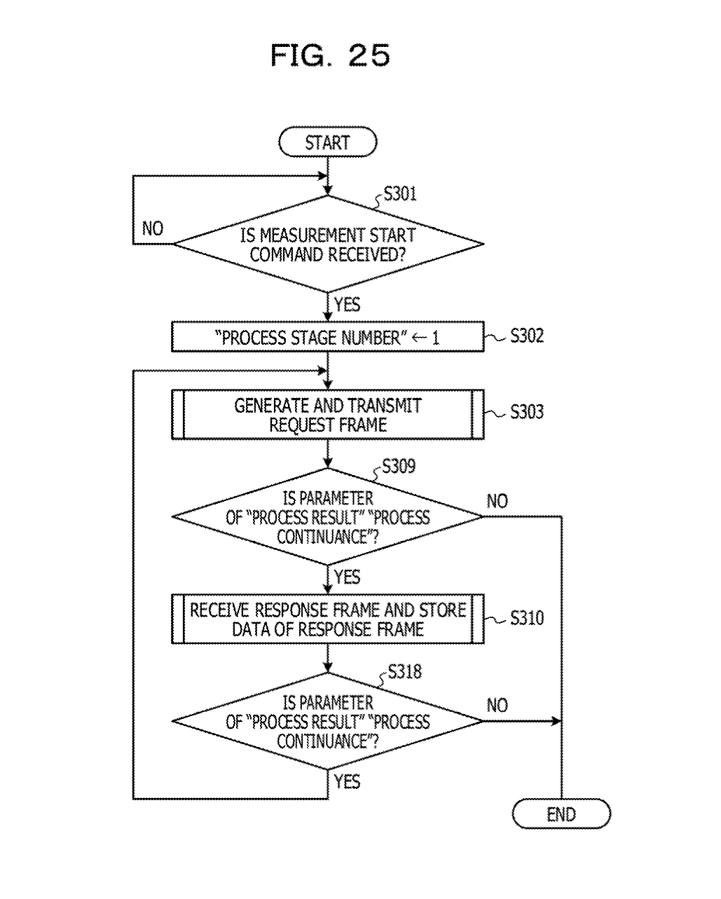

FIG. 25 is a flow chart illustrating a process for acquiring data of a mounting position from a different blade, which is executed by a reference blade in the second embodiment.

First, the position specification unit 30 of the reference blade 200 decides whether or not a measurement start command is received from the monitoring apparatus 130 (S301). If it is decided that a measurement start command is not received (S301: No), the position specification unit 30 returns its process to S301 and executes the process at S301 again. On the other hand, if it is decided that a measurement start command is received (S301: Yes), the position specification unit 30 sets “1” to a parameter for a “process stage number” (S302). The “process stage number” is a variable representative of a stage number of a blade 100, which is a target for acquisition of position information, with respect to the reference blade. For example, the stage number of the reference blade 200 is zero. The stage number of a blade 100 of a next stage positioned just below the reference blade 200 is one.

Then, the lower face side communication unit 70 of the reference blade 200 at the uppermost stage generates and transmits a request frame to the blade 100 at the next stage below (S303). The request frame is a frame for requesting specification of the mounting position. Here, the process for generating and transmitting a request frame is described.

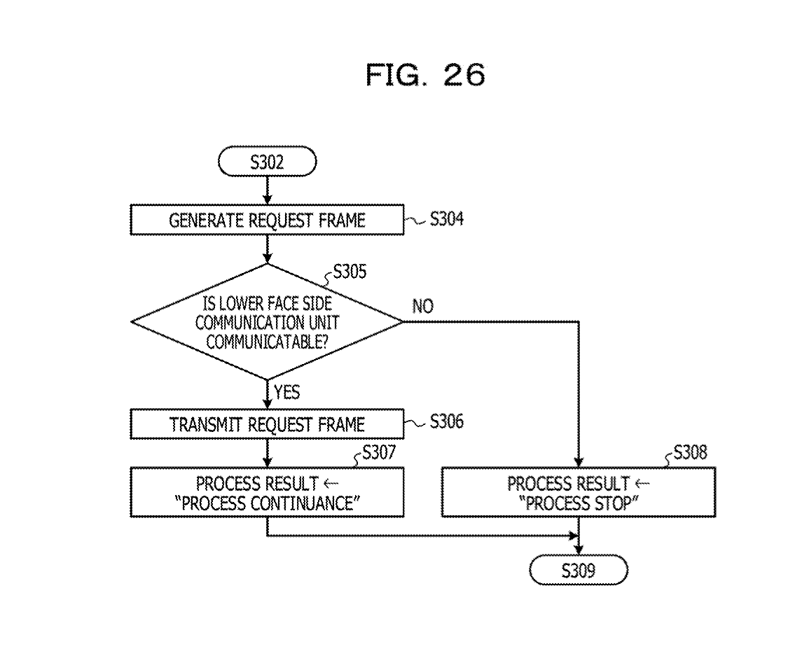

FIG. 26 is a flow chart illustrating an example of a process for generating and transmitting a request frame at S303.

First, the position specification unit 30 generates a request frame (S304).

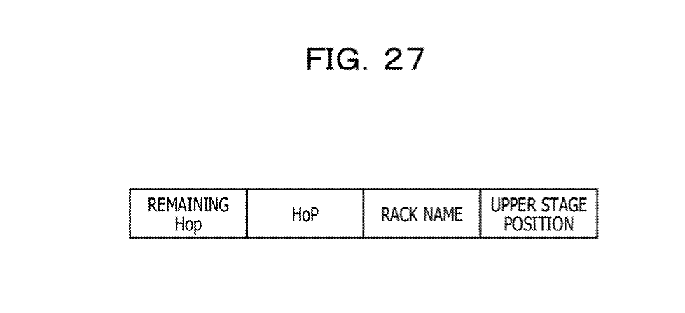

FIG. 27 is a view illustrating an example of a format of a request frame. As depicted in FIG. 27, the request frame has respective fields for “Remaining Hop,” “Hop,” “Rack name,” and “Upper stage position.” “Remaining Hop” is a parameter indicating a stage number to a blade of a destination. For example, a blade that receives a request frame checks “Remaining Hop” of the request frame and decides, if 1 is stored in “Remaining Hop,” that the request frame is destined for the own apparatus. On the other hand, if 1 is not stored in “Remaining Hop,” the blade subtracts 1 from the value in “Remaining Hop” and transfers a resulting value to a blade 100 at the next stage below. By subtracting 1 from the value in “Remaining Hop” every time it is decided that 1 is not stored in “Remaining Hop” in this manner, when a request frame arrives at a blade 100 of a destination passing through some blades, a state in which the value of “Remaining Hop” is 1 may be created. “Hop,” “Rack name,” and “Upper stage position” are parameters similar to “Hop,” “Rack name,” and “Upper stage position” in the format of the request frame illustrated in FIG. 16, respectively.

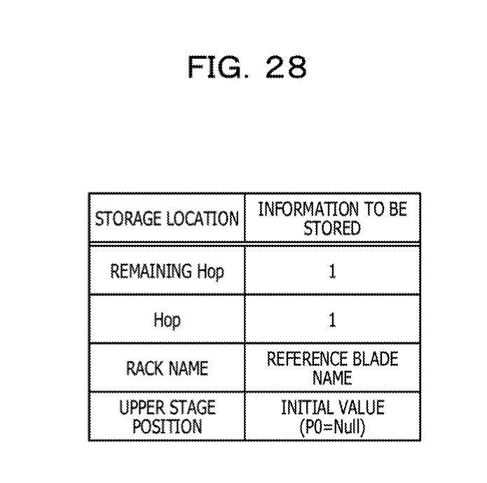

FIG. 28 is a view illustrating an example of data stored in respective fields of a request frame at an initial stage at S304. The request frame at the initial stage is generated by the reference blade 200 at the uppermost stage. Accordingly, in the respective fields of “Remaining Hop” and “Hop” of the request frame, information of “1” indicating the first stage is stored as an initial value of the process stage number. In the “Rack name” field, the reference blade name is stored. Since the reference blade 200 and the transmission source of the request frame at the initial stage are same, information of “Null” representing zero is stored as a value of the relative distance P0 described hereinabove stored in the “Upper stage position” field.

Referring back to FIG. 26, after the process at S304, the position specification unit 30 decides whether or not the lower face side communication unit 70 is communicatable (S305). At S305, the position specification unit 30 refers to a flag corresponding to the “lower face side communication unit” stored in the communication state table 21 to decide whether or not the lower face side communication unit 70 is communicatable. If it is decided that the lower face side communication unit 70 is communicatable (S305: Yes), the lower face side communication unit 70 transmits a request frame (S306). Then, the position specification unit 30 places “process continuance” into the parameter of “process result” in the second storage unit 20a (S307). Then, the series of processes for generating a request frame is ended. On the other hand, if it is decided that the lower face side communication unit 70 is not communicatable (S305: No), since it is not possible to transmit the request frame downwardly, the position specification unit 30 places “process stop” into the parameter of “process result” (S308). Then, the series of processes for generating a request frame is ended.

The process at S303 is executed in such a manner as described above.

Referring back to FIG. 25, after the process at S303, the position specification unit 30 decides whether or not the parameter of “process result” is “process continuance” (S309). If the parameter of “process result” is not “process continuance, for example, if the parameter is “process stop” (S309: No), the position specification unit 30 ends the series of processes by the reference blade 200. On the other hand, if it is decided that the parameter of “process result” is “process continuance” (S309: Yes), the position specification unit 30 receives a response frame and places data of the response frame into the overall position information table 24 (S310). Here, the process for placing the data of the response frame into the overall position information table 24 is described.

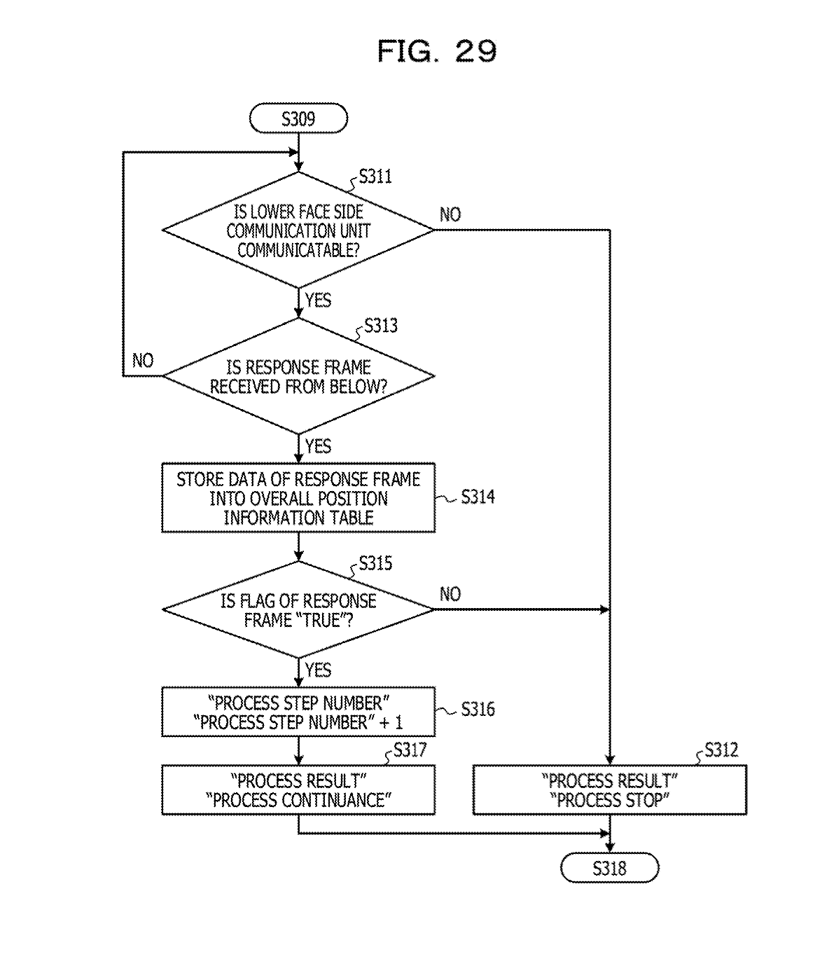

FIG. 29 is a flow chart illustrating an example of a process for placing data of a response frame.

First, the position specification unit 30 decides whether or not the lower face side communication unit 70 is communicatable (S311). If it is decided that the lower face side communication unit 70 is not communicatable (S311: No), since the reference blade 200 fails to receive a response frame from below, the position specification unit 30 places “process stop” into the parameter of “process result” (S312). Then, the series of processes placing data of a response frame is ended. On the other hand, if it is decided that the lower face side communication unit 70 is communicatable (S311: Yes), the position specification unit 30 decides whether or not a response frame is received from below (S313).

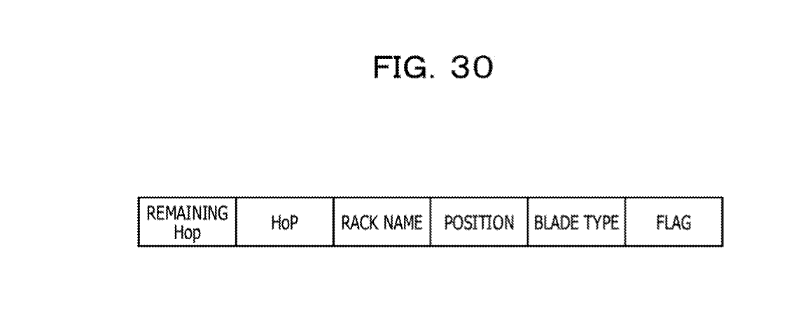

FIG. 30 is a view illustrating an example of a format of a response frame. As depicted in FIG. 30, the response frame has respective fields for “Remaining Hop,” “Hop,” “Rack name,” “Position,” “Blade type,” and “Flag.” “Remaining Hop,” “Hop,” and “Rack name” are parameters similar to “Remaining Hop,” “Hop,” and “Rack name” in the format of the request frame illustrated in FIG. 27, respectively. “Position” indicates a relative distance of the lower face of the blade of the transmission source of the response frame where the position of the blade of the transmission source of the response frame, for example, the position of the lower face of the reference blade 200, is determined as a start point. “Blade type” indicates the name of the blade of the transmission source. “Flag” is a flag for deciding by the reference blade 200 whether or not the blade 100 of the transmission source of the response frame is a blade 100 at the lowermost stage. In the present embodiment, if “TRUE” is set in “Flag,” the reference blade 200 may recognize that the blade 100 of the transmission source of the response frame is not a blade 100 at the lowermost stage. On the other hand, if “FALSE” is set in “Flag,” the reference blade 200 may recognize that the blade 100 of the transmission source of the response frame is a blade 100 at the lowermost stage.

Referring back to FIG. 29, if it is decided at S313 that a response frame is not received (S313: No), the position specification unit 30 returns the process to S311 to repeat the processes at the steps beginning with S311 again. On the other hand, if it is decided that a response frame is received (S313: Yes), the position specification unit 30 places the data of the response frame into the overall position information table 24 (S314).

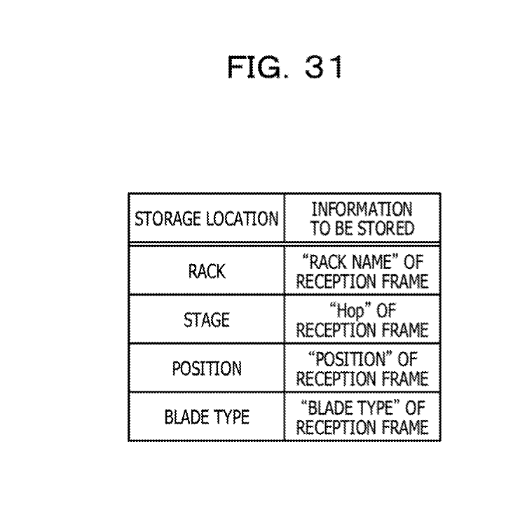

FIG. 31 is a view illustrating data stored in an overall position information table. As illustrated in FIG. 31, in the item of “Rack” of the overall position information table 24, data stored in the “Rack name” field of the reception frame is stored. In the item of “Stage,” data stored in the “Hop” field of the reception frame is stored. In the item of “Position,” data stored in the “Position” field of the reception frame is stored. In the item of “Blade type,” data stored in the “Blade type” field of the reception frame is stored.

Referring back to FIG. 29, after the process at S314, the position specification unit 30 decides whether or not “Flag” of the response frame indicates “TRUE” (S315). If “Flag” of the response frame does not indicate “TRUE” (S315: No), “Flag” of the response frame indicates “FALSE.” This indicates that the transmission source of the response frame is a blade 100 at the lowermost stage, and this signifies that the position information of all of the plurality of blades 100 is aggregated successfully by the reference blade 200. Therefore, the position specification unit 30 advances the process to S312, at which it places “process stop” into the parameter of “process result.” Then, the series of processes for placing data of the response frame is ended.

On the other hand, if “Flag” in the response frame indicates “TRUE” (S315: Yes), this indicates that the transmission source of the response frame is the intermediate blade, and this signifies that the position information of all of the plurality of blades 100 is not aggregated successfully in the reference blade 200. Therefore, the position specification unit 30 adds 1 to the parameter of “process stage number” in order to set the blade 100 at the stage one stage below the blade 100 of the transmission source of the response frame as a new target for acquisition of position information (S316).

Thereafter, the position specification unit 30 places “process continuance” into the parameter of “process result” (S317). Then, the series of processes for placing data of the response frame is ended.

The process at S310 is executed in such a manner as described above.

Referring back to FIG. 25, after the process at S310, the position specification unit 30 decides whether or not the parameter of “process result” is “process continuance” (S318). If the parameter of “process result” is “process continuance” (S318: Yes), the position specification unit 30 returns its process to S303 and executes the processes at the steps beginning with S303 again. On the other hand, if it is decided that the parameter of “process result” is not “process continuance” (S318: No), “process result” indicates “process stop.” Therefore, the position specification unit 30 ends the series of processes.

The reference blade 200 acquires data of the mounting position from a different blade 100 in such a manner as described above.

Now, a process executed by each of the plurality of blades 100 other than the reference blade 200 in the second embodiment is described.

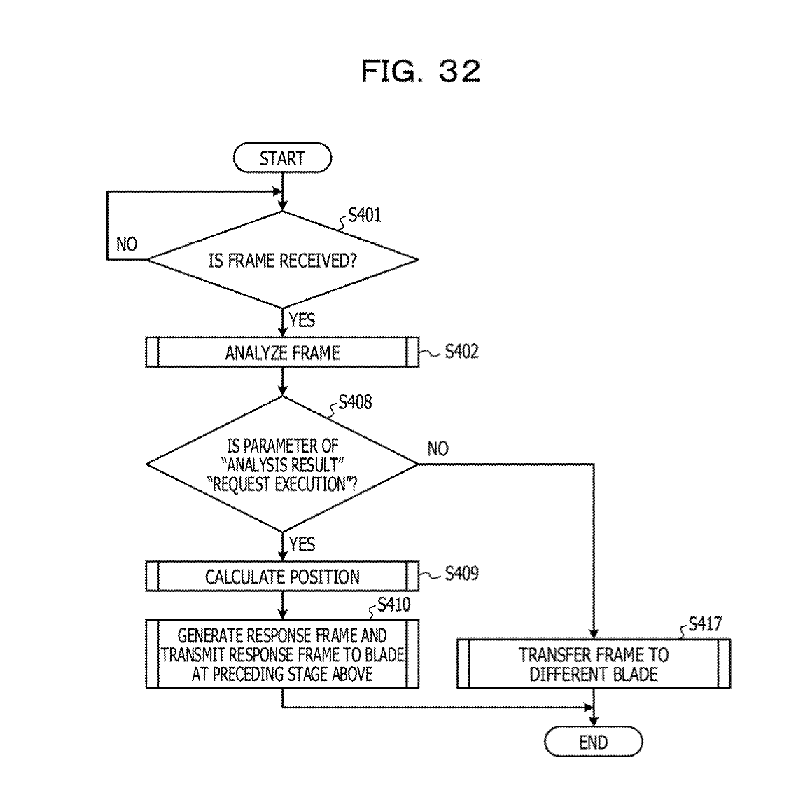

FIG. 32 is a flow chart illustrating a process for specifying a mounting position in an open rack, which is executed by each of a plurality of blades other than a reference blade in the open rack in the second embodiment. Here, description is given assuming that the process is executed by a target blade in the plurality of blades 100.

First, the position specification unit 30 of the target blade decides whether or not a frame is received (S401). If it is decided that a frame is not received (S401: No), the position specification unit 30 executes the process at S401 again. On the other hand, if it is decided that a frame is received (S401: Yes), the position specification unit 30 analyzes the received frame (S402). Here, the process for analyzing the frame is described.

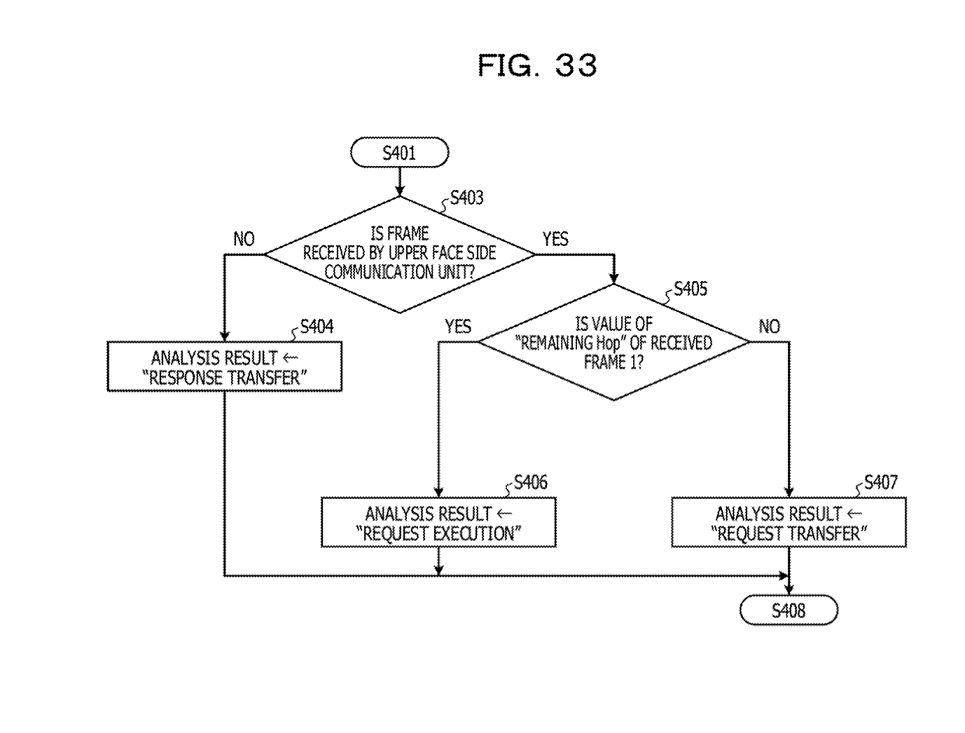

FIG. 33 is a flow chart illustrating an example of a process for analyzing a frame at S402.

First, the position specification unit 30 decides whether or not the frame is received by the upper face side communication unit 60 (S403). If it is decided that the frame is not received by the upper face side communication unit 60, for example, if it is decided that the frame is received by the lower face side communication unit 70 (S403: No), the position specification unit 30 decides that the received frame is a response frame to be transferred toward the reference blade 200 above. Therefore, the position specification unit 30 places “response transfer” into the parameter of “analysis result” (S404). Then, the series of processes for analyzing the frame is ended.

On the other hand, if it is decided that the frame is received by the upper face side communication unit 60 (S403: Yes), the position specification unit 30 decides whether or not the value of “Remaining Hop” in the received frame is “1” (S405). If it is decided that the value of “Remaining Hop” is “1” (S405: Yes), it is decided that the received frame is a request frame destined for the own apparatus. Therefore, the position specification unit 30 places “request execution” into the parameter of “analysis result” (S406). Then, the series of processes for analyzing the frame is ended. On the other hand, if it is decided that the value of “Remaining Hop” is not “1” (S405: No), it is decided that the received frame is not a request frame destined for the own apparatus but is a request frame to be transferred toward the blade 100 at the next stage below. Therefore, the position specification unit 30 places “request transfer” into the parameter of “analysis result” (S407). Then, the series of processes for analyzing the frame is ended. The process at S402 is executed in such a manner as described above.

Referring back to FIG. 32, after the process at S402, the position specification unit 30 decides whether or not the parameter of “analysis result” is “request execution” (S408). If it is decided that the parameter of “analysis result” is “request execution” (S408: Yes), the position specification unit 30 calculates the position of the target blade with respect to the reference blade 200 (S409). At S409, processes similar to the processes at S204 to S206 of FIG. 13 in the first embodiment are executed. Therefore, detailed description of them is omitted herein.

After S409, the position specification unit 30 generates and transmits a response frame to the blade 100 at the preceding stage above (S410). Here, the process for generating and transmitting a response frame is described.

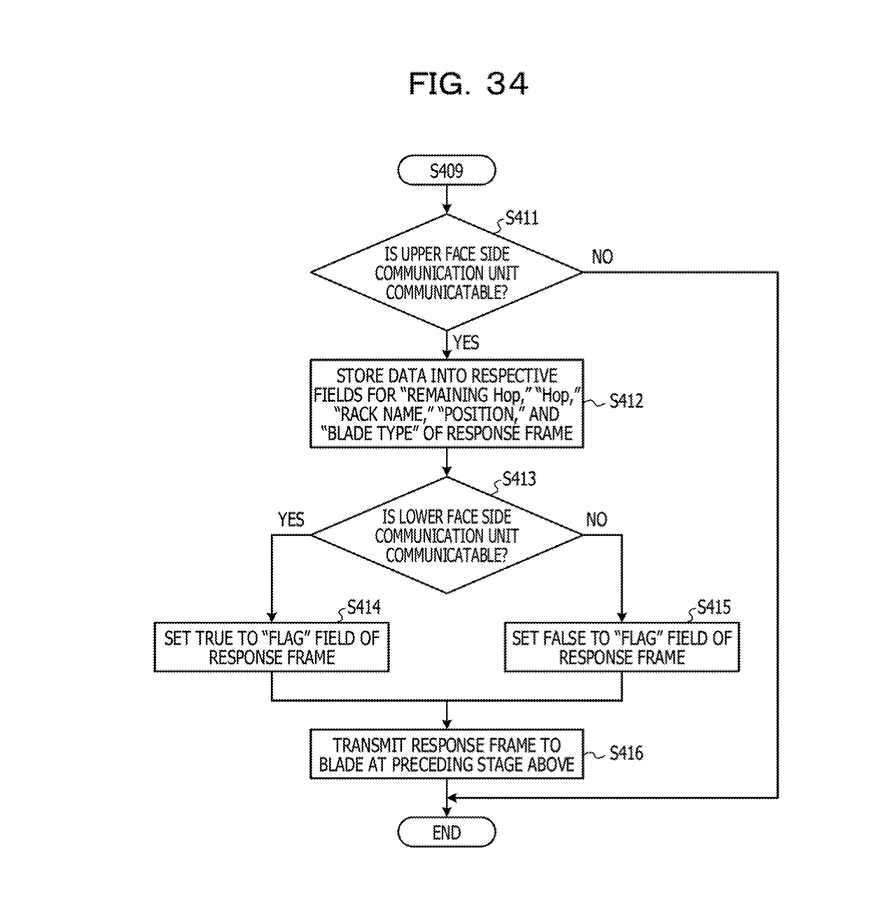

FIG. 34 is a flow chart illustrating an example of a process for generating and transmitting a response frame at S410.

First, the position specification unit 30 decides whether or not the upper face side communication unit 60 is communicatable (S411). If it is decided that the upper face side communication unit 60 is not communicatable (S411: No), since the target blade fails to transmit the response frame upwardly, the series of processes is ended. On the other hand, if it is decided that the upper face side communication unit 60 is communicatable (S411: Yes), the position specification unit 30 places data into the respective fields for “Remaining Hop,” “Hop,” “Rack name,” “Position,” and “Blade type” of the response frame (S412).

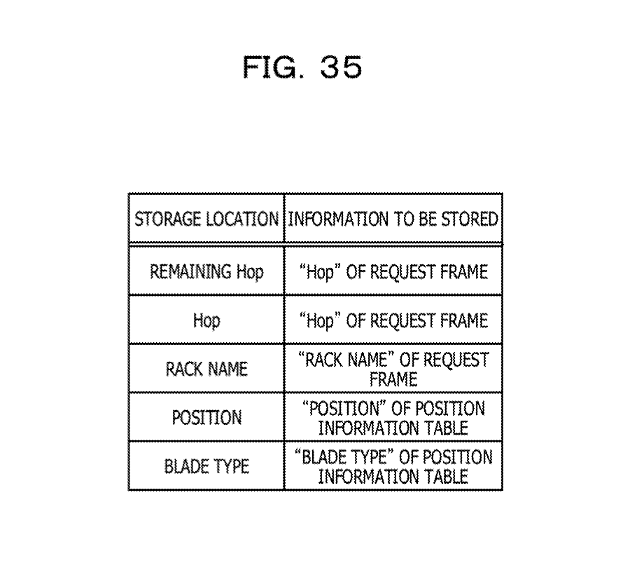

FIG. 35 is a view illustrating data stored into respective fields of a response frame. As depicted in FIG. 35, into the “Remaining Hop” field of the response frame, data stored in the “Hop” field of the request frame is stored. Into the “Hop” field, data stored in the “Hop” field of the request frame is stored. Into the “Rack name” field, data stored in the “Rack name” field of the request frame is stored. Into the “Position” field, data stored in the item of “Position” of the position information table 23 is stored. Into the “Blade type” field, data stored in the item of “Blade type” of the position information table 23 is stored.

Referring back to FIG. 34, after the process at S412, the position specification unit 30 decides whether or not the lower face side communication unit 70 is communicatable (S413). If it is decided that the lower face side communication unit 70 is communicatable (S413: Yes), the position specification unit 30 decides that a blade whose position information is to be collected by the reference blade 200 exists below. Therefore, the position specification unit 30 sets “TRUE” to the “Flag” field of the response frame (S414). Then, the upper face side communication unit 60 transmits the response frame to the blade at the preceding stage above (S416).

On the other hand, if it is decided that the lower face side communication unit 70 is not communicatable (S413: No), the position specification unit 30 decides that the blade whose position information is to be collected by the reference blade 200 does not exist below (S415). Then, the upper face side communication unit 60 transmits the response frame to the blade at the preceding stage above (S416). The process at S410 is executed in such a manner as described above.

Referring back to FIG. 32, if it is decided at S408 that “process result” is not “request execution” (S408: No), the position specification unit 30 transfers the frame to a different blade 100 (S417). Here, the process for transferring the frame to a different blade 100 is described.

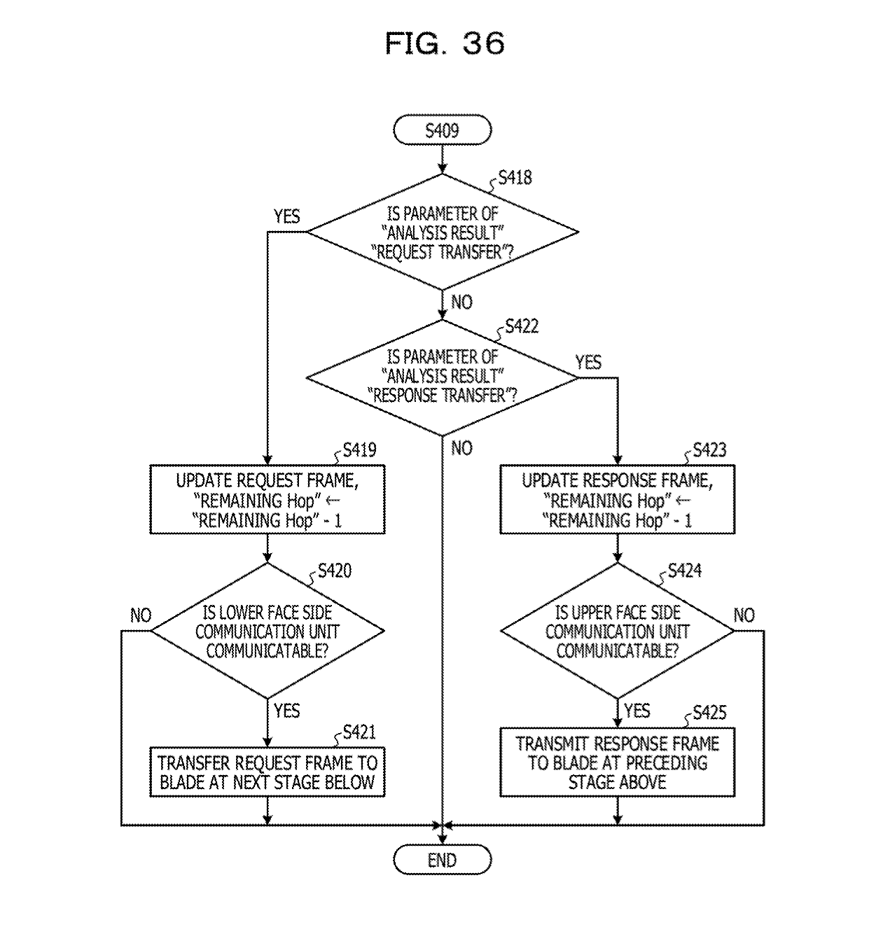

FIG. 36 is a flow chart illustrating an example of a process for transferring a frame at S417.

First, the position specification unit 30 decides whether or not “analysis result” is “request transfer” (S418). If it is decided that “analysis result” is “request transfer” (S418: Yes), the position specification unit 30 updates the request frame by subtracting 1 from the value of the “Remaining Hop” field of the request frame (S419).

Then, the position specification unit 30 decides whether or not the lower face side communication unit 70 is communicatable (S420). If it is decided that the lower face side communication unit 70 is communicatable (S420: Yes), the position specification unit 30 transfers the request frame to the blade 100 at the next stage below (S421). On the other hand, if it is decided that the lower face side communication unit 70 is not communicatable (S421: No), since the target blade is not capable of transmitting the request frame downwardly, the series of processes is ended.

On the other hand, if it is decided at S418 that the parameter of “analysis result” is not “request transfer” (S418: No), the position specification unit 30 decides whether or not the parameter of “analysis result” is “response transfer” (S422). If it is decided that the parameter of “analysis result” is not “response transfer” (S422: No), since a process for the received frame is not permitted, the series of processes is ended. On the other hand, if it is decided that the parameter of “analysis result” is “response transfer” (S422: Yes), the position specification unit 30 updates the response frame by subtracting 1 from the value of the “Remaining Hop” field of the response frame (S423).

Thereafter, the position specification unit 30 decides whether or not the upper face side communication unit 60 is communicatable (S424). If it is decided that the upper face side communication unit 60 is communicatable (S424: Yes), the position specification unit 30 transfers the response frame to the blade 100 at the preceding stage above (S425). On the other hand, if it is decided that the upper face side communication unit 60 is not communicatable (S424: No), since the target blade is not capable of transmitting the response frame upwardly, the series of processes is ended. The process at S417 is executed in such a manner as described above.

Each of the blades 100 other than the reference blade 200 specifies the mounting position thereof in the open rack 120 in such a manner as described above.

After the process described above is executed by all of the blades 100 other than the reference blade 200 in the open rack 120, information of the mounting position of all of the blades 100 in the open rack 120 is stored in the overall position information table 24 of the reference blade 200.

When the user of the monitoring apparatus 230 wants to grasp the mounting position of each of the plurality of blades 100 mounted on the open rack 120, the user would transmit a request command to the reference blade 200. The reference blade 200 transmits information stored in the overall position information table 24 to the monitoring apparatus 230 in response to the request command. Then, the monitoring apparatus 230 displays received information on the display device 135. Consequently, the user of the monitoring apparatus 230 may grasp the mounting position of all of the blades 100 mounted on the open rack 120.

Now, a particular example of the process for specifying a mounting position, which is executed by each of the plurality of blades 100 disposed in such a manner as depicted in FIG. 22, is described with reference to flow charts of FIGS. 25, 26, 29, 32 to 34, and 36 using a sequence diagram.

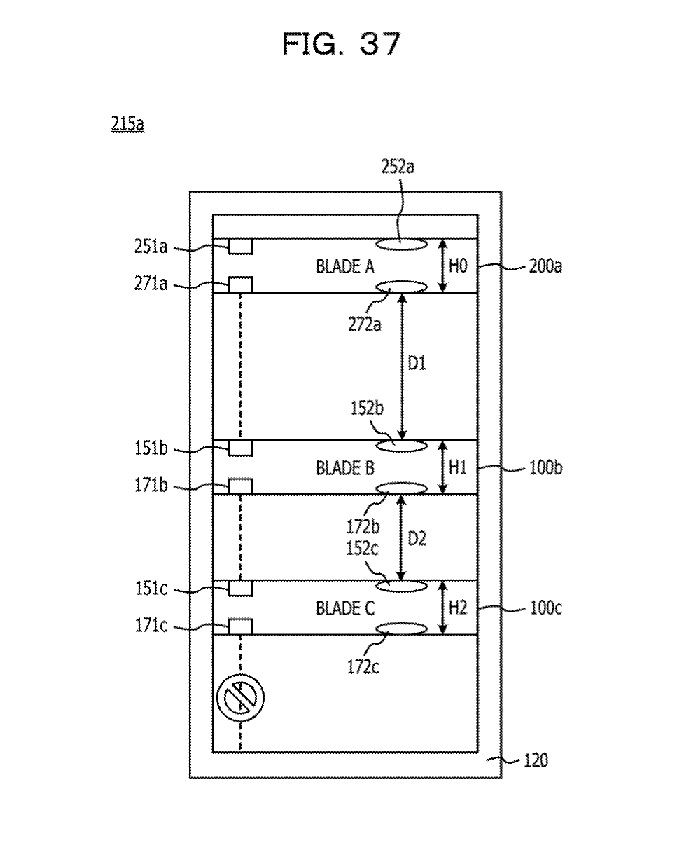

FIG. 37 is a view depicting an example of disposition of a plurality of blades in a transmission apparatus in the second embodiment. The same components to those in the first embodiment are denoted by the same reference symbols those in the first embodiment, and description of them is omitted herein. As depicted in FIG. 37, a transmission apparatus 215a includes an open rack 120, and a blade A 200a, another blade B 100b, and a further blade C 100c disposed in the open rack 120.

The blade A 200a corresponds to the blade 100 at the uppermost stage and the apparatus height thereof is H0. The blade A 200a includes a communication port 251a and a distance detection sensor 252a on the upper face side thereof and includes a communication port 271a and a distance detection sensor 272a on the lower face side thereof.

The blade B 100b is an intermediate blade and the apparatus height thereof is H1. The blade B 100b includes a communication port 151b and a distance detection sensor 152b on the upper face side thereof and includes a communication port 171b and a distance detection sensor 172b on the lower face side thereof.

The blade C 100c corresponds to a blade 100 at the lowermost stage and the apparatus height thereof is H2. The blade C 100c includes a communication port 151c and a distance detection sensor 152c on the upper face side thereof and includes a communication port 171c and a distance detection sensor 172c on the lower face side thereof.

The interval between the blade A 200a and the blade B 100b, for example, the distance between the lower face of the blade A 200a and the upper face of the blade B 100b, is D1. The interval between the blade B 100b and the blade C 100c, for example, the distance between the lower face of the blade B 100b and the upper face of the blade C 100c, is D2.

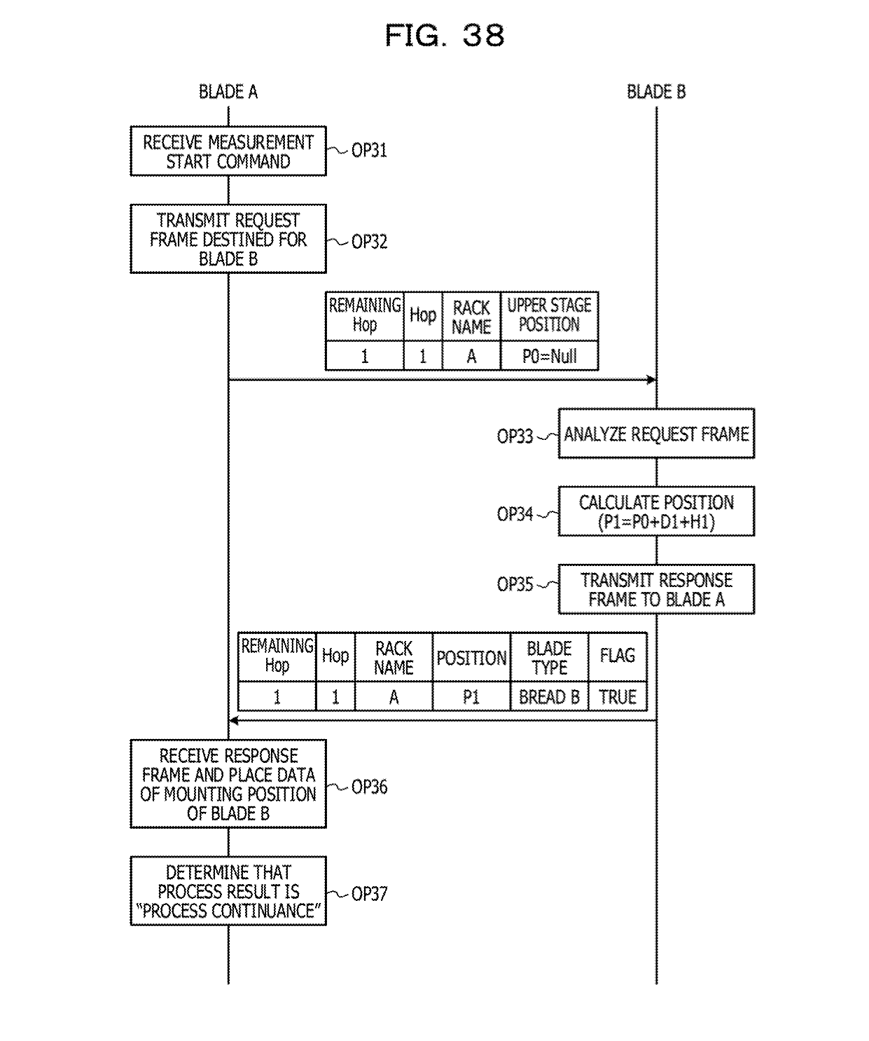

FIG. 38 is a sequence diagram (part 1) of a process for specifying a mounting position, which is executed by each of a plurality of blades in the second embodiment.

First, the blade A 200a set as a reference blade decides that a measurement start command is received at S301 (OP31). Then, the blade A 200a generates a request frame destined for the blade B 100b and transmits the request frame to the blade B 100b at S302 (OP32). In the “Remaining Hop” and “Hop” fields of the request frame transmitted from the blade A 200a, “1” indicating the stage number of the blade B 100b when the blade A 200a is set as a reference (stage number: 0) is stored. In the “Rack name” field, “A” indicating the name of the open rack 120 is stored. In the “Upper stage position” field, information of “P0=Null” indicating that the distance between the lower face of the reference blade and the lower face of the blade A 200a is zero is stored. Then, the blade A 200a places “process continuance” into the parameter of “process result.”

The blade B 100b that receives the request frame decides that a frame is received at S401. Then, the blade B 100b analyzes the frame at S402 and decides that it indicates an execution process for the request frame. Then, the blade B 100b places “request execution” as a result of the analysis into the “analysis result” parameter (OP33). Thereafter, the blade B 100b decides at S408 that the “analysis result” parameter is “request execution” and calculates the position at which it is mounted at S409 (OP34). Then, the blade B 100b generates and transmits a response frame to the blade at the preceding stage above, for example, to the blade A 200a at S410 (OP35). In the “Remaining Hop” field of the response frame, “1” stored in the “Hop” field of the request frame is stored. In the “Hop” field, “1” stored in the “Hop” field of the reception frame is stored. In the “Rack name” field, “A” stored in the “Rack name” field of the request frame is stored. In the “Position” field, the value of P1 stored in the item of “Position” of the position information table 23 the blade B 100b has is stored. In the “Blade type” field, “blade B” stored in the item of “Blade type” of the position information table 23 the blade B 100b has is stored. In the “Flag” field, “TRUE” indicating that the next stage blade exists below the transmission source is stored.

In the blade A 200a that receives the response frame, data of the mounting position of the blade B included in the response frame is stored into the overall position information table 24 at S314 (OP36). Thereafter, the blade A 200a decides at S315 that the flag of the response frame is “TRUE,” and adds 1 to the parameter of “process stage number” at S316. Thereafter, the blade A 200a places “process continuance” into the parameter of “process result” at S317.

Thereafter, the blade A 200a decides at S318 that the parameter of “process result” is “process continuance” (OP37). Then, the blade A 200a returns the process to S302 in order to continue process.

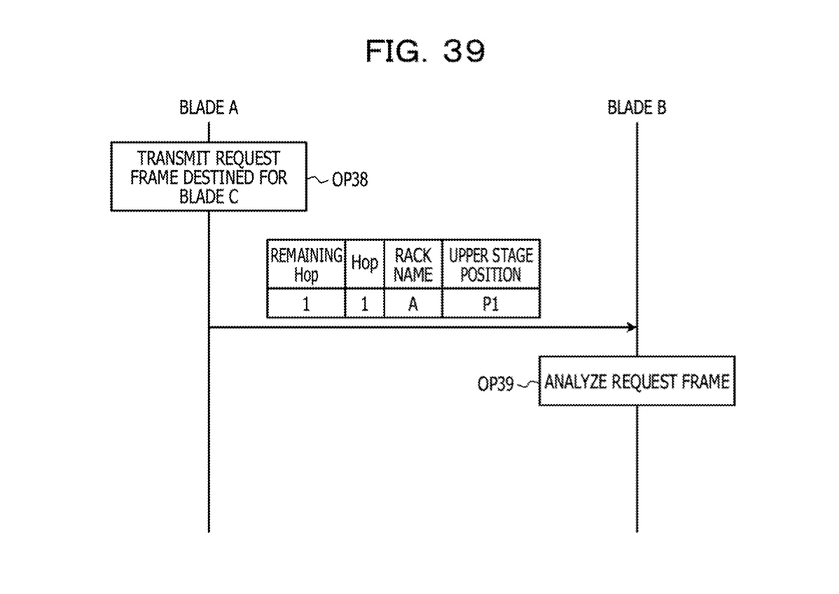

FIG. 39 is a sequence diagram (part 2) of a process for specifying a mounting position, which is executed by each of a plurality of blades in the second embodiment.

As depicted in FIG. 39, the blade A 200a generates a request frame destined for the blade C 100c and transmits the request frame to the blade B 100b at S302 (OP38). In the “Remaining Hop” and “Hop” fields of the request frame transmitted from the blade A 200a, “2” indicating the stage number of the blade C 100c when the blade A 200a is set as a reference (step number: 0) is stored. In the “Rack name” field, “A” indicating the name of the open rack 120 is stored. In the “Upper stage position” field, information of the value of the distance P1 between the lower face of the reference blade and the lower face of the blade B 100b that is the blade at the upper stage is stored.

The blade B 100b that receives the request frame analyzes the frame at S402 (OP39). The blade B 100b decides at S405 that the received frame indicates a transfer process of the request frame because the value of “Remaining Hop” of the received frame is not 1. Then at S407, the blade B 100b places “request transfer” into the “analysis result” parameter as a result of the analysis.

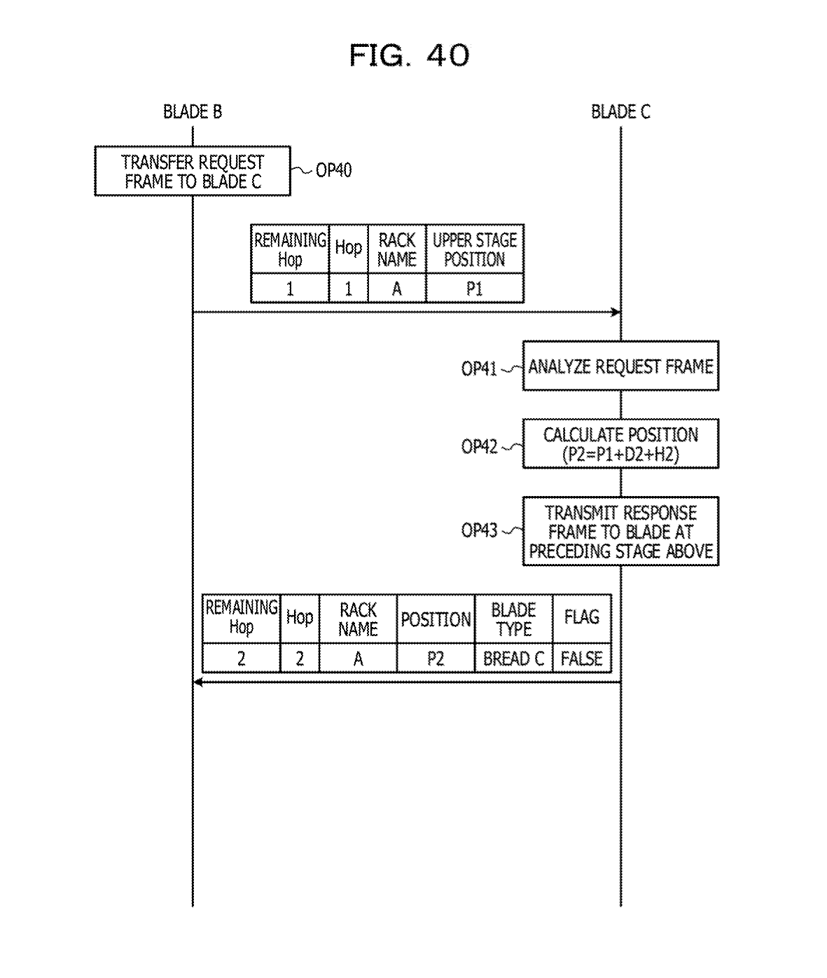

FIG. 40 is a sequence diagram (part 3) of a process for specifying a mounting position, executed by each of a plurality of blades in the second embodiment.

The blade B 100b decides at S409 after OP39 that the parameter of “analysis result” is not “request execution,” and advances the process to S417. Then, the blade B 100b decides at S419 that the “analysis result” parameter is “request transfer” and transfers, at S421, the request frame to the next stage blade below, for example, to the blade C (OP40). In “Remaining Hop” of the request frame transferred from the blade B 100b, “1” that is a value obtained by decrementing the process stage number by 1 is stored. In the respective other fields, information same as that in the request frame received from the blade A 200a by the blade B 100b is stored.

The blade C 100c that receives the request frame analyzes the frame at S402 (OP41). The blade C 100c decides at S405 that the received frame indicates an execution process of the request frame because the value of “Remaining Hop” of the received frame is 1. Then, at S407, the blade C 100c places “request execution” as an analysis result into the “analysis result” parameter. Thereafter, the blade C 100c decides at S408 that the “analysis result” parameter indicates “request execution” and calculates a position at which the blade C 100c is mounted at S409 (OP42). Thereafter, the blade C 100c generates a response frame at S410 and transmits the response frame to the blade at the preceding stage above, for example, to the blade B 100b (OP43). In the “Remaining Hop” field of the response frame, “2” stored in the “Hop” field of the request frame is stored. In the “Hop” field, “2” stored in the “Hop” field of the reception frame is stored. In the “Rack name” field, “A” stored in the “Rack name” field of the request frame is stored. In the “Position” field, the value of P2 stored in the item of “Position” of the position information table 23 the blade C 100c has is stored. In the “Blade type” field, “blade C” stored in the item of “Blade type” of the position information table 23 the blade C 100c has is stored. In the “Flag” field, “FALSE” indicating that the next stage blade does not exist below the transmission source is stored.

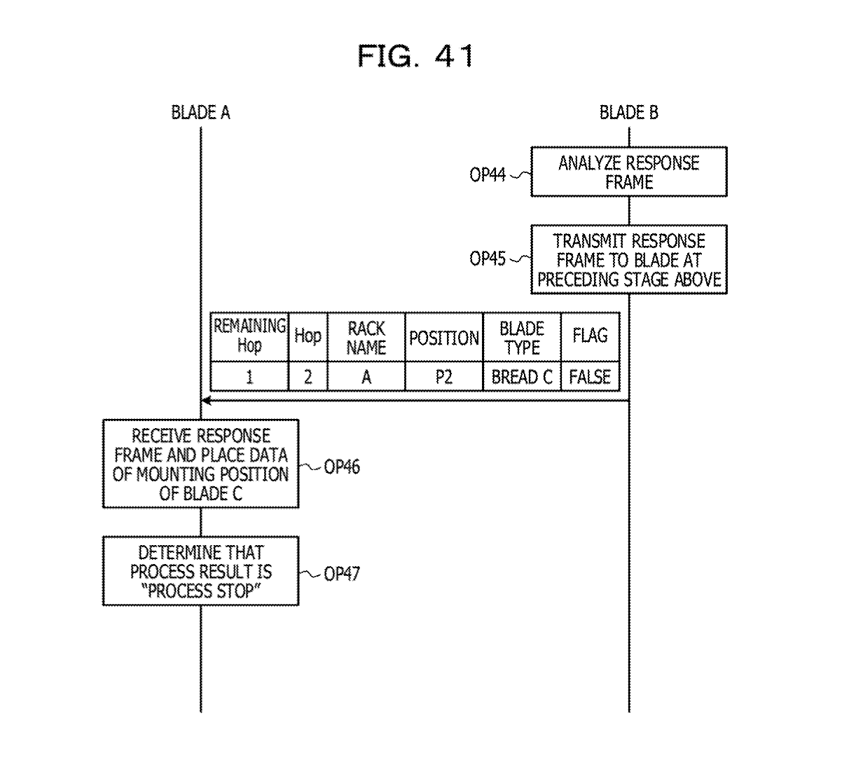

FIG. 41 is a sequence diagram (part 4) of a process for specifying a mounting position, which is executed by each of a plurality of blades in the second embodiment.

The blade B 100b that receives the response frame analyzes the frame at S402 (OP44). The blade B 100b decides at S403 that the frame indicates a transfer process of the response frame because the frame has not been received by the upper face side communication unit. Then, at S404, the blade B 100b places “response transfer” as an analysis result into the “analysis result” parameter. Thereafter, the blade B 100b decides at S408 that the “analysis result” parameter is not “request execution,” and advances the process to S417. Then, the blade B 100b decides at S422 that the “analysis result” parameter is “response transfer” and transfers, at S425, the response frame to the preceding stage blade above, for example, to the blade A (OP45). In “Remaining Hop” of the response frame transferred from the blade B 100b, “1” that is a value obtained by incrementing the process stage number by one stage is stored. In the respective other fields, information same as that in the response frame received from the blade C 100c by the blade B 100b is stored.

The blade A 200a that receives the response frame places data of the mounting position of the blade C included in the response frame into the overall position information table 24 at S314 (OP46). Thereafter, the blade A 200a decides at S315 that the flag of the response frame is not “TRUE” because the flag is “FALSE” and places, at S317, “process stop” into the parameter of “process result.” Thereafter, the blade A 200a decides at S318 that the parameter of “process result” is not “process continuance,” for example, is “process stop” (OP47) and then ends the process as the reference blade.

The process for specifying the mounting position of each of the plurality of blades depicted in FIG. 37 is executed in such a manner as described above.

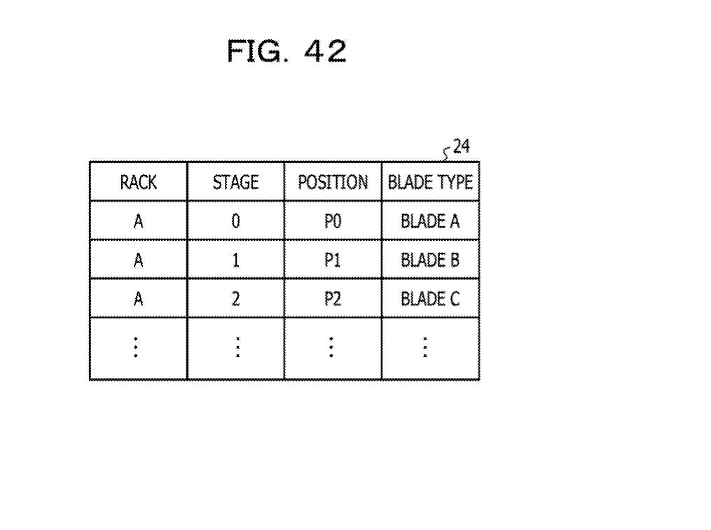

FIG. 42 is a view illustrating an example of an overall position information table stored in each of the plurality of blades depicted in FIG. 37. As depicted in FIG. 42, it is indicated that, at the 0th stage of the open rack whose rack name is A, the blade A is mounted at the position of P0. It is indicated that, at the first stage of the open rack whose rack name is A, the blade B is mounted at the position of P1. It is indicated that, at the second stage of the open rack whose rack name is A, the blade C is mounted at the position of P2.

When the user of the monitoring apparatus 230 wants to grasp the mounting position of all of the blades mounted on the open rack A, the user would transmit a request command to the blade A 200a. The blade A 200a transmits the information stored in the overall position information table 24 to the monitoring apparatus 230 in response to the request command. Then, the monitoring apparatus 230 displays the received information on the display device 135. Also in the second embodiment, for example, such a display form as depicted in FIG. 21B may be used. Consequently, the user of the monitoring apparatus 230 may grasp the mounting position of all of the blades 100 mounted on the open rack A.

According to the second embodiment, the reference blade collects information of the mounting positions from the respective other blades 100 in the open rack 120. According to this method, since the information of the mounting position of all of the blades 100 mounted on the open rack 120 is aggregated on the reference blade, the monitoring apparatus may acquire information readily only by accessing to the reference blade.

### Third Embodiment

Now, a third embodiment is described. In the first embodiment, all of the blades 100 in the open rack 120 have a distance measurement sensor at both the upper face side and the lower face side thereof. In contrast, in the third embodiment, each of the blades in the open rack 120 other than a reference blade is characterized by having only one of the distance detection sensor provided at the upper face side and the distance detection sensor provided at the lower face side thereof. In the third embodiment, where a reference blade is determined in advance, one of such two distance measurement sensors as described above is omitted to simplify the configuration of each blade.

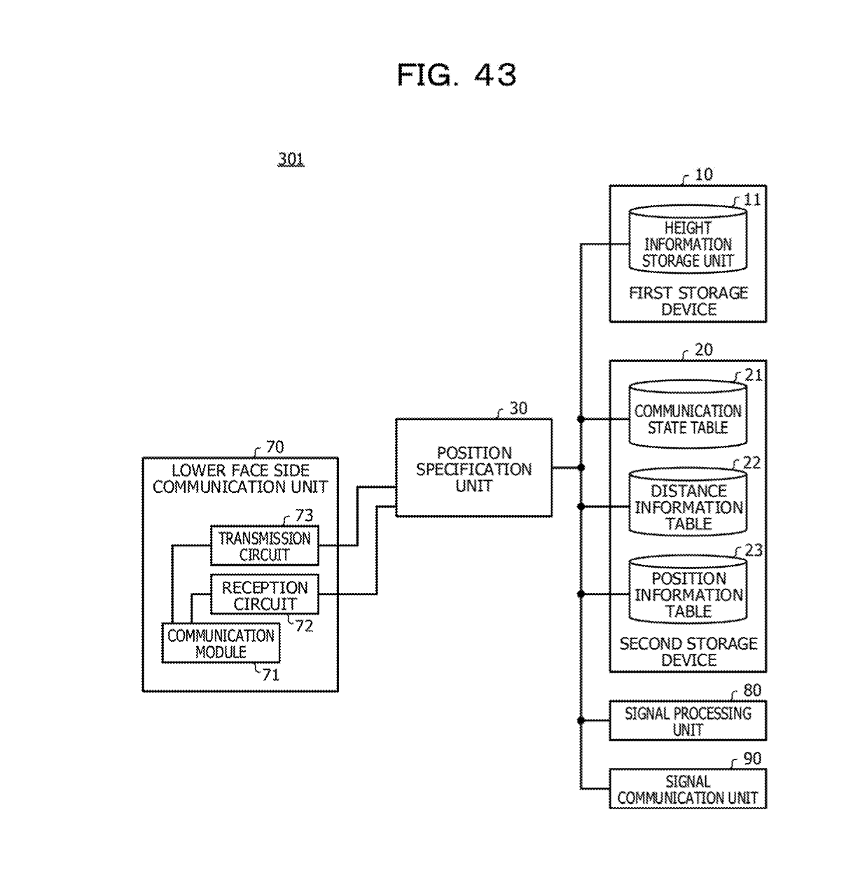

In the following, the third embodiment is described with reference to FIGS. 43 to 48. The hardware configuration view of each blade in the third embodiment is similar to the hardware configuration view in the first embodiment, and therefore, description of the configuration is omitted herein. The same functional blocks to those in the first embodiment are denoted by the same reference symbols to those in the first embodiment, and description of them is omitted herein. The following description is given assuming that a blade at the uppermost stage from among a plurality of blades in the open rack 120 is set as a reference blade in advance.

FIG. 43 is a view depicting an example of a functional block diagram of a reference blade in the third embodiment. As depicted in FIG. 43, a reference blade 301 includes a first storage unit 10, a second storage unit 20, a position specification unit 30, a lower face side communication unit 70, a signal processing unit 80, and a signal communication unit 90. If the functional block diagram of FIG. 43 is compared with the functional block diagram of the first embodiment depicted in FIG. 2, it may be recognized that the reference blade 301 does not include the upper face side distance detection unit 40, the lower face side distance detection unit 50, and the upper face side communication unit 60.

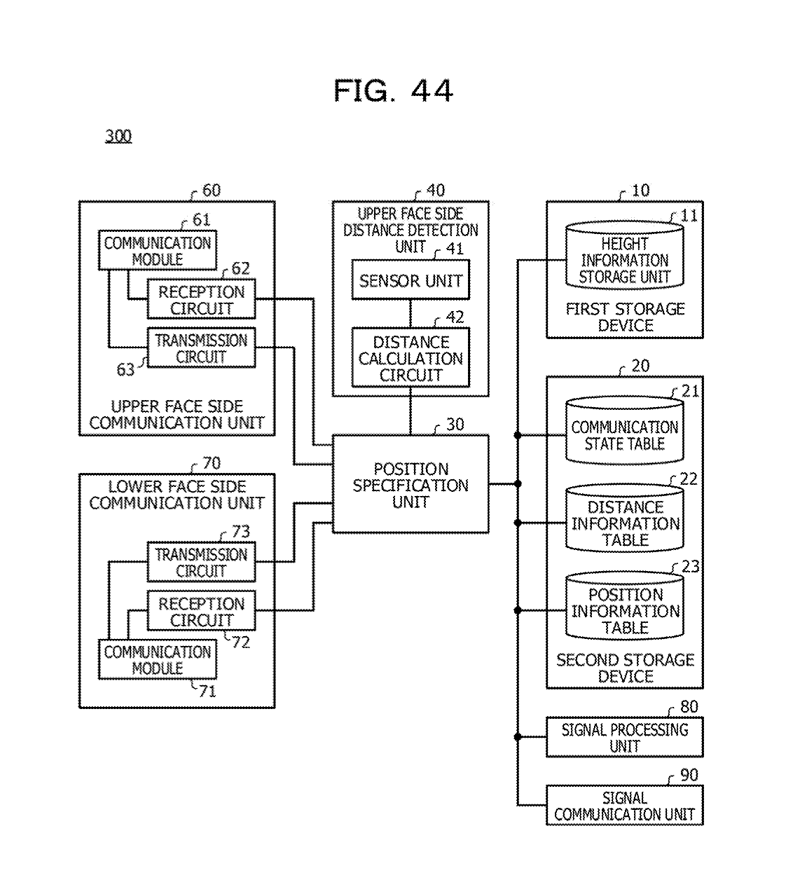

FIG. 44 is a view depicting an example of a functional block diagram of each blade other than a reference blade in an open rack in the third embodiment. As depicted in FIG. 44, a blade 300 includes a first storage unit 10, a second storage unit 20, a position specification unit 30, an upper face side distance detection unit 40, an upper face side communication unit 60, a lower face side communication unit 70, a signal processing unit 80, and a signal communication unit 90. If the functional block diagram of FIG. 44 is compared with the functional block diagram of the blade 100 in the first embodiment depicted in FIG. 2, it may be recognized that the blade 300 does not include the lower face side distance detection unit 50.

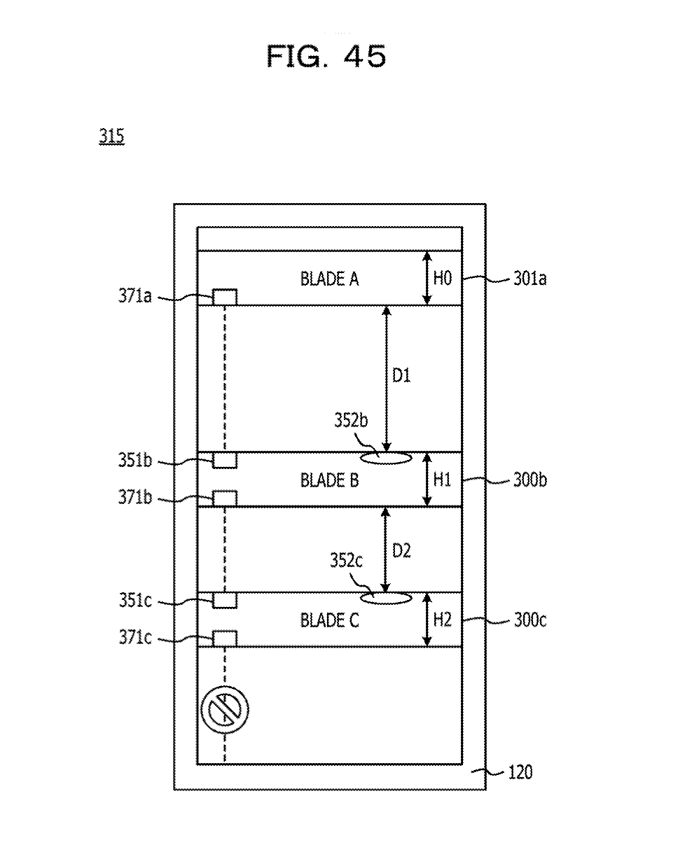

FIG. 45 is a view depicting an example of disposition of a plurality of blades in a transmission apparatus in the third embodiment. As depicted in FIG. 45, a transmission apparatus 315 includes an open rack 120, and a blade A 301a, a blade B 300b, and a blade C 300c provided in the open rack 120.

The blade A 301a corresponds to the reference blade 301 at the uppermost stage, and the apparatus height thereof is H0. The blade A 301a includes a communication port 371a on the lower face side thereof. Since a different blade 300 does not exist above the blade A 301a, the communication port and the distance detection sensor on the upper face side of the blade A 301a may be omitted. Since measurement of the distance between the blade A 301a and the blade B 300b is performed by the blade B 300b, also the distance detection sensor on the lower face side of the blade 301a may be omitted.

The blade B 300b is an intermediate blade and the apparatus height thereof is H1. The blade B 300b includes a communication port 351b and a distance detection sensor 352b on the upper face side thereof and includes a communication port 371b on the lower face side thereof. Since measurement of the distance between the blade B 300b and the blade C 300c is performed by the blade C 300c, the distance detection sensor on the lower face side of the blade B 300b may be omitted. The interval between the blade A 301a and the blade B 300b, for example, the distance between the lower face of the blade A 301a and the upper face of the blade B 300b, is D1.

The blade C 300c corresponds to the blade 300 at the lowermost stage and the apparatus height thereof is H2. The blade C 300c includes a communication port 351c and a distance detection sensor 352c on the upper face side thereof and includes a communication port 371c on the lower face side thereof. Since a different blade 300 does not exist below the blade C 300c, the distance detection sensor on the lower face side of the blade C 300c may be omitted. The interval between the blade B 300b and the blade C 300c, for example, the distance between the lower face of the blade B 300b and the upper face of the blade C 300c, is D2.

Now, a process for specifying a positional relationship with a different blade 300, which is executed by each blade 300 other than the reference blade 301 is described.

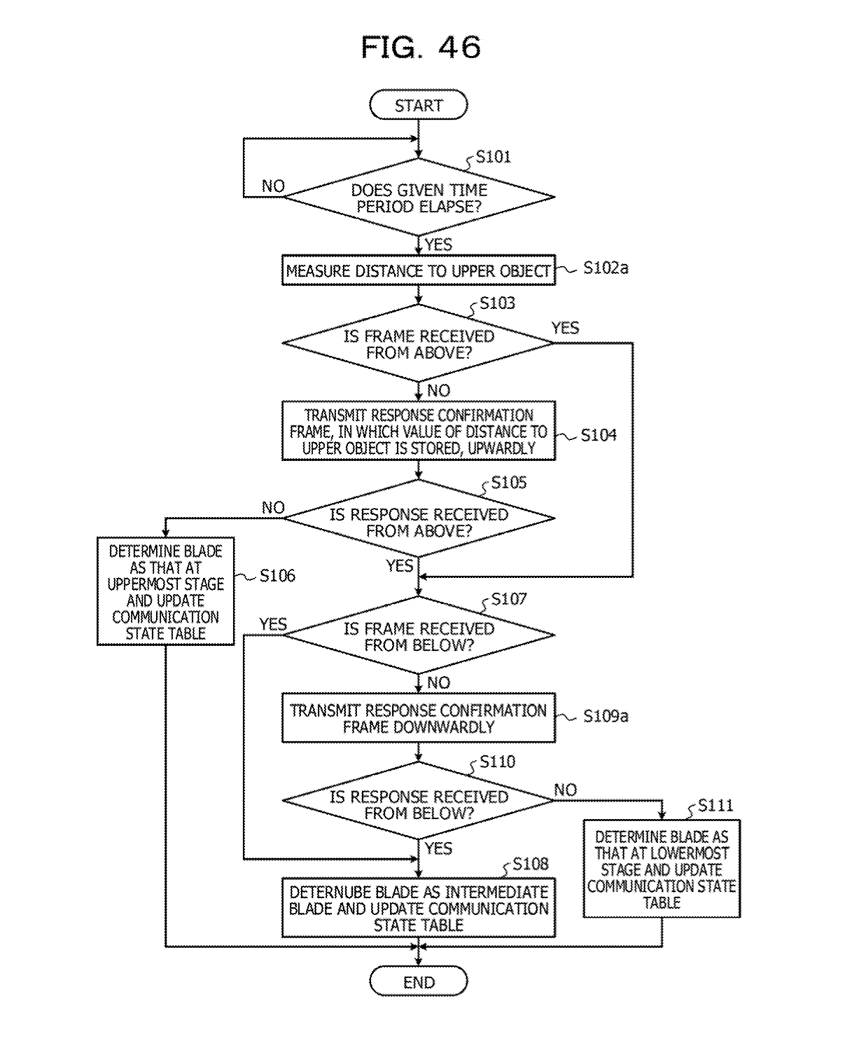

FIG. 46 is a flow chart illustrating a process for specifying a positional relationship with a different blade, which is executed by each blade other than a reference blade in the third embodiment.

At process at S101 is similar to the process at S101 in the first embodiment, and therefore, description of the process is omitted herein.

If it is decided at S101 that a given period of time elapses (S101: Yes), the position specification unit 30 measures the distance between the blade 300 and an upper object through the upper face side distance detection unit 40 (S102a). The position specification unit 30 places a value of the distance to the upper object into a distance information table 22a in the second storage unit 20.

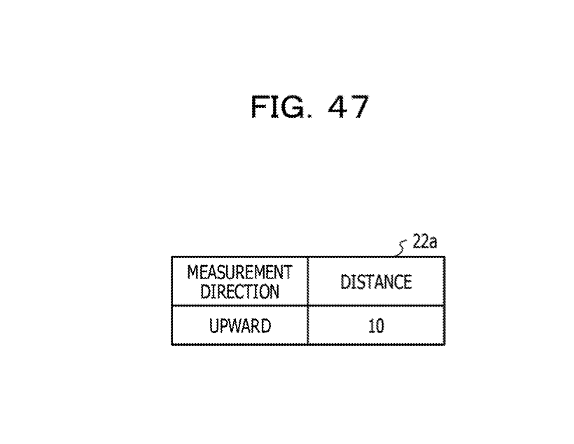

FIG. 47 is a view illustrating an example of a distance information table. The distance information table 22a has an item of Measurement direction and an item of Distance similarly as in the distance information table 22 in the first embodiment illustrated in FIG. 6. However, in the third embodiment, since each blade 300 other than the reference blade 301 does not measure the distance to a lower object, in the item of Measurement direction, only “upward” from between “upward” and “downward” is set in advance. Further, in the item of Distance, as a result of the process at S102a, for example, information of “10” is stored as a value of the distance to the upper object.

Referring back to FIG. 46, after the process at S102a, the process advances to S103. The processes from S103 to the end through S106 and the processes when, after the decision of Yes is made at step S103 through S107, the process advances to S108 until the process comes to an end are similar to the processes executed at the steps denoted by the same step numbers in the first embodiment illustrated in FIG. 5, and therefore, description of the process is omitted herein.

If a decision of No is made at S107, the position specification unit 30 transmits a response confirmation frame downwardly (S109a). In the third embodiment, since the distance to a lower object is not measured, a value of the distance to the lower object is not stored in the field of “Distance” of the response confirmation frame. After the process at S109a, the process advances to S110. The respective processes executed at S110 to the end are similar to the respective processes executed at the steps denoted by the same step numbers in the first embodiment illustrated in FIG. 5, and therefore, description of them is omitted herein. Also the communication state table 21 updated through the processes illustrated in FIG. 46 is similar to the communication state table 21 in the first embodiment illustrated in FIG. 8, and therefore, description of them is omitted herein.

The series of processes for specifying a positional relationship with a different reference blade 300 is executed in such a manner as described above.

Now, a particular example of the process for specifying a positional relationship with a different blade, which is executed by each of a plurality of blades, is described with reference to a flow chart of FIG. 46 using a sequence diagram.

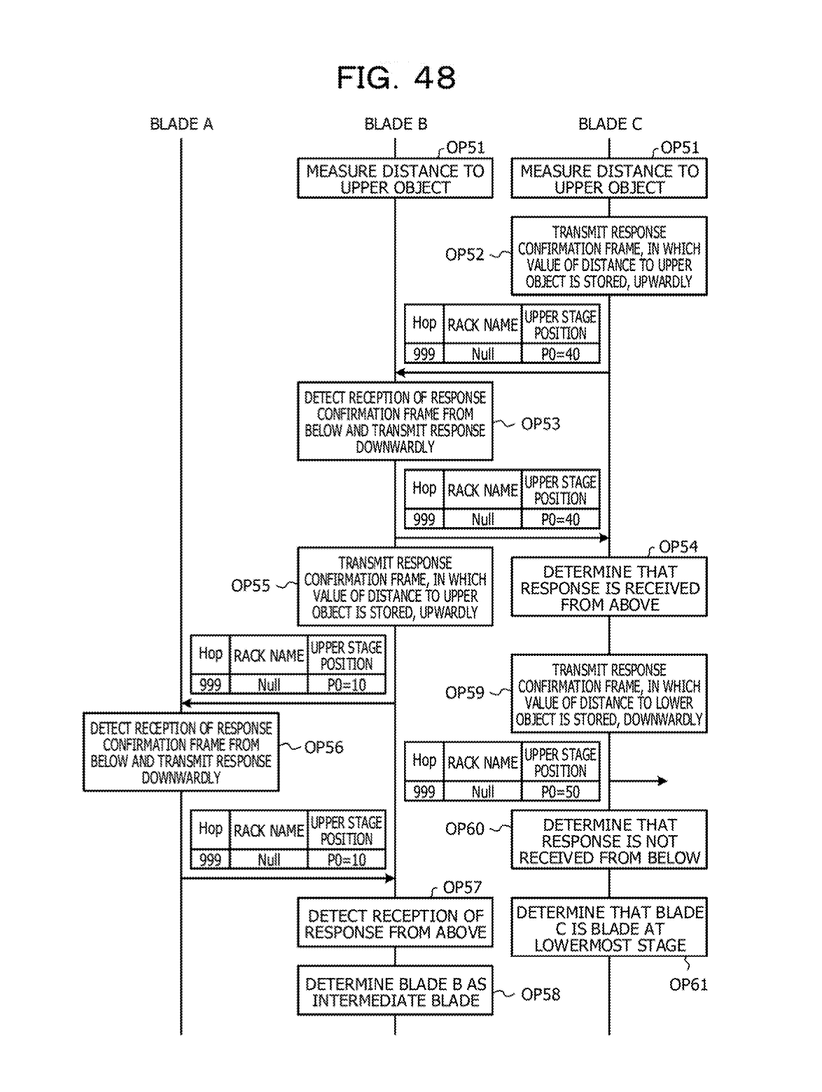

FIG. 48 is an example of a sequence diagram of a process for specifying a positional relationship with a different blade, which is executed by each of a plurality of blades in the third embodiment.

The blade B 300b and the blade C 300c individually measure, when it is decided at S101 that the given period of time elapses, the distance to an upper object at S102a (OP51).

If, after the OP51, it is decided at S103 that a frame is not received from above, the blade C 300c transmits, at S104, a response confirmation frame, in which a value of the distance to the upper object is stored, upwardly, for example, toward the blade B 300b (OP52). In the “Hop” field of the response confirmation frame transmitted from the blade C 300c, “999” is stored. In the “Rack name” field, “Null” is stored. In the “Distance” field, “40” representative of the distance between the upper face of the blade C 300c and the upper object, for example, the lower face of the blade B 300b, is stored.

The blade B 300b detects, before it starts the process at S103, reception of the response confirmation frame from below, for example, from the blade C 300c and transmits a response downwardly (OP53). This response has information same as that of the reference confirmation frame received from the blade C 300c.

The blade C 300c receives the response from the blade B 300b and decides that a response is received from above at S105 (OP54). Then, the process advances to S107.

The blade B 300b decides at S103 that a frame is not received from above and transmits a response confirmation frame, in which a value of the distance to the upper object is stored, upwardly, for example, toward the blade A 301a at S104 (OP55). In the “Hop” field of the response confirmation fame transmitted from the blade B 100b, “999” is stored. In the “Rack name” field, “Null” is stored. In the “Distance” field, the value of “10” indicating the distance between the upper face of the blade B 300b and the upper object, for example, the lower face of the blade A 301a, is stored.

The blade A 301a detects reception of the response confirmation frame from below, for example, from the blade B 300b, and transmits a response downwardly (OP56). This response has information same as that of the response confirmation frame received from the blade B 300b. The blade A 301a updates the communication state table 21 based on the information of the distance extracted from the response confirmation table and then ends the process.

The blade B 300b detects the response from the blade A 301a (OP57) and decides at S105 that a response is received from above. Then, the blade B 300b decides at S107, based on that the response confirmation fame is received from the blade C 300c by OP52, that a frame is received from below. Then, the process advances to S108. At S108, the blade B 300b decides that the own apparatus is an intermediate blade and updates the communication state table 21 (OP58).

Since the blade C 300c does not receive a frame from below, it decides at S107 that it does not receive a frame from below and transmits, at S109, a response confirmation frame, in which a value of the distance to the lower object is stored, downwardly (OP59). In the “Hop” field of the response confirmation frame transmitted from the blade C 300c, “999” is stored. In the “Rack name” field, “Null” is stored. In the “Distance” field, the value of “999” indicating the distance between the lower face of the blade C 300c and the lower object is stored.

Since the blade C 300c does not receive a response to the response confirmation frame from below even after a given waiting time period elapses, it decides at S110 that a response is not received from below (OP60). Then, the process advance to S111. At S111, the blade C 300c decides that the own apparatus is a blade 300 at the lowermost stage and updates the communication state table 21 (OP61).

The series of processes for specifying a positional relationship with a different blade 300, which is executed by each of the plurality of blades 300, is executed in such a manner as described above. If the series of processes is compared with that of the sequence diagram in the first embodiment depicted in FIG. 12, it may be recognized that the processes, for example, by the blade A 100a are omitted significantly.

The process for specifying a mounting position in the open rack, which is executed by each of the plurality of blades, is similar to that of the flow chart in the first embodiment illustrated in FIG. 13, and therefore, description of the process is omitted herein.

Although the foregoing description of the embodiment is given assuming a case in which a blade at the uppermost stage is determined in advance as the reference blade 301, also it is possible to assume a case in which a blade at the lowermost stage is determined in advance as the reference blade 301. In this case, from the reference blade 301 at the lowermost stage, both the distance detection sensor at the upper face side and the distance detection sensor at the lower face side are omitted. Each of the blades 300 other than the reference blade 301 at the lowermost stage includes, from between the distance detection sensor at the upper face side and the distance detection sensor at the lower face side, only the distance detection sensor at the lower face side.

According to the third embodiment, where the reference blade 301 is determined in advance, only one of the distance detection sensor at the upper face side and the distance detection sensor at the lower face side is provided in each of the blades 300 other than the reference blade 301. According to this method, since the apparatus configuration of each blade is simplified, reduction of the production cost of the apparatus may be anticipated.

### Fourth Embodiment

Now, a fourth embodiment is described. In the second embodiment, the reference blade includes the overall position information table 24, and all of the blades 100 in the open rack 120 individually include distance measurement sensors on both the upper face side and the lower face side. In contrast, in the fourth embodiment, it is characterized that the reference blade includes the overall position information table 24, and each of the blades 100 other than the reference blade in the open rack 120 includes only one of the distance detection sensor at the upper face side and the distance detection sensor at the lower face side. Also the fourth embodiment is simplified in configuration of each blade 100 by omitting, where a reference blade is determined in advance, one of the two distance measurement sensors similarly as in the third embodiment.

The system and the transmission apparatus in the fourth embodiment are similar in configuration to those of the second embodiment depicted in FIGS. 21 and 22, individually. The process for specifying a positional relationship with a different blade 100, which is executed by each of the plurality of blades 100 in the open rack 120 in the fourth embodiment, is similar to the process in the first embodiment illustrated in FIG. 12. In the fourth embodiment, the process of the reference blade for acquiring data of a mounting position from a different blade 100 is similar to the process in the second embodiment illustrated in FIG. 24. Therefore, detailed description of the process is omitted herein.

Also by the fourth embodiment, since each blade 100 is simplified in apparatus configuration, reduction of the production cost of the apparatus may be anticipated.

### Fifth Embodiment

Now, a fifth embodiment is described. In the second embodiment, the second storage unit 20a holds the overall position information table 24. In contrast, in the fifth embodiment, it is characterized that a monitoring apparatus includes an overall position information table. In the first embodiment, each of the plurality of blades 100 in the open rack 120 executes a process for specifying a mounting position when it receives a measurement start command from the monitoring apparatus 130. In contrast, in the fifth embodiment, a process for acquiring data of a mounting position from a different blade 100, it is characterized that a process for specifying a mounting position in the open rack 120 and a process for updating an overall position information table the monitoring apparatus has are executed at given time intervals.

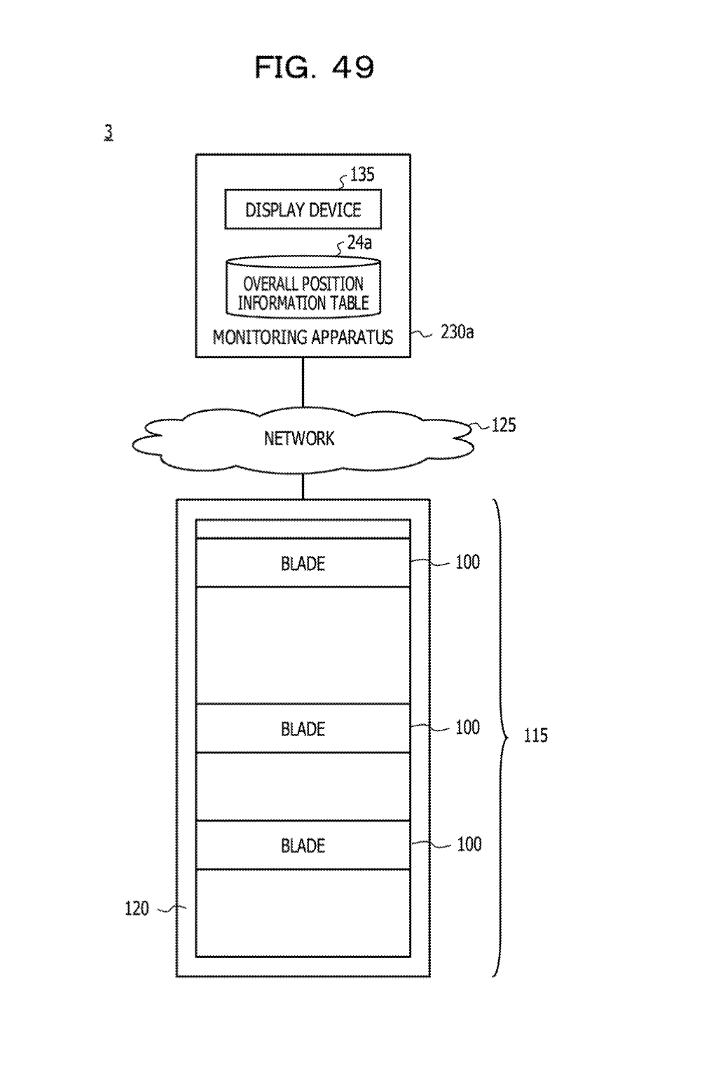

In the following, the fifth embodiment is described with reference to FIGS. 49 to 51.

FIG. 49 is a view depicting an example of a system in the fifth embodiment. The same components to those in the first embodiment are denoted by the same reference symbols to those in the first embodiment, and description of them is omitted herein. As depicted in FIG. 49, a system 3 includes a transmission apparatus 115 and a monitoring apparatus 230a. The transmission apparatus 115 and the monitoring apparatus 230a are coupled to each other by a network 125 such that they may communicate with each other.

The transmission apparatus 115 executes, at given intervals of time, a process for acquiring data of a mounting position of a different blade 100, another process for specifying the mounting position of each of the plurality of blades 100 in the open rack 120, and a further process for transmitting information of the specified mounting positions to the monitoring apparatus 230a from each of the plurality of blades 100.

The monitoring apparatus 230a includes a display device 235 and an overall position information table 24a. The monitoring apparatus 230a receives information of a mounting position from each of the plurality of blades 100 of the transmission apparatus 215 at given intervals of time. Then, the monitoring apparatus 230a places the acquired information into the overall position information table 24a. The monitoring apparatus 230a may update the overall position information table 24a to the latest information at the given intervals of time by executing the processes described above. Further, the monitoring apparatus 230a displays the overall position information table 24a on the screen of the display device 235 as occasion demands. Consequently, the user of the monitoring apparatus 230a may grasp the blade configuration of the transmission apparatus 115 without issuing a command to the transmission apparatus 115. A first storage unit is an example of the overall position information table 24a.

The following description is given of the embodiment where a blade 100 at the uppermost stage is set as a reference blade. The process for specifying a positional relationship with a different blade 100, which is executed by each of the plurality of blades 100, is similar to that in the first embodiment, and therefore, description of the process is omitted herein.

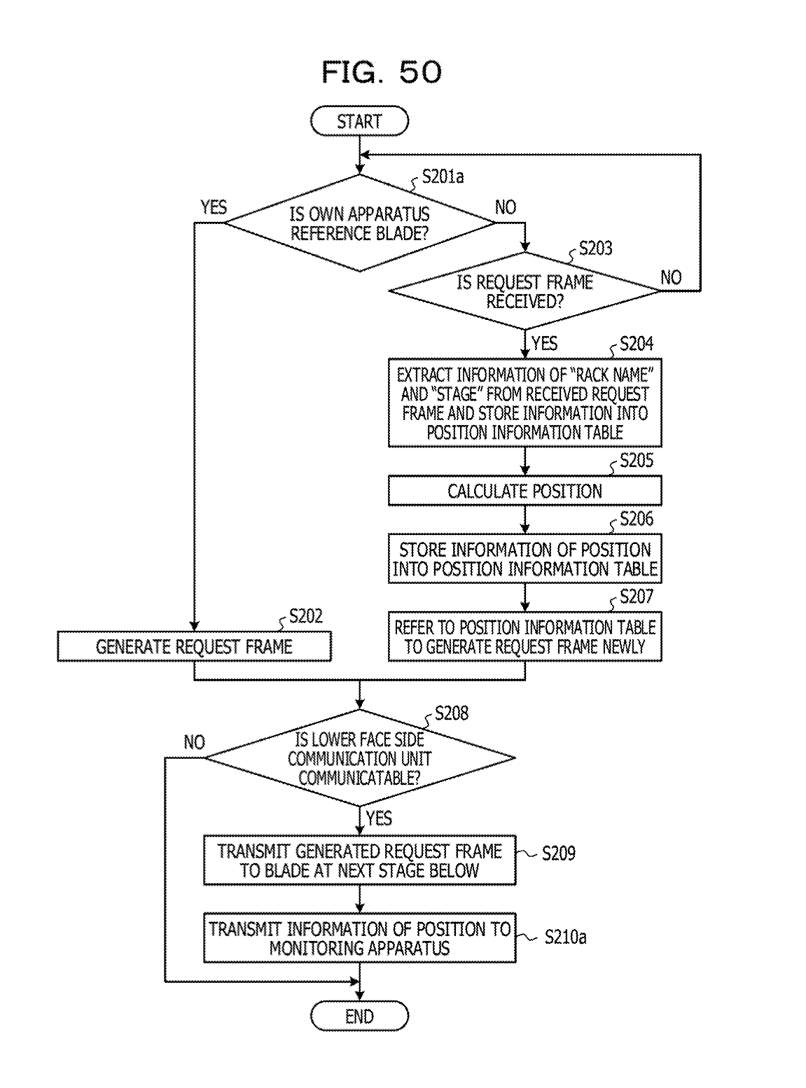

FIG. 50 is a flow chart illustrating a process for specifying a mounting position in an open rack, which is executed by each of a plurality of blades in the fifth embodiment.

First, the position specification unit 30 decides whether or not the own apparatus is a reference blade (S201a). Where a blade at the uppermost stage is set as a reference blade, a decision of Yes is made at S201a if it is decided by the process at S106 illustrated in FIG. 5 that the own apparatus is a blade 100 at the uppermost stage. On the other hand, if it is decided by the process at S108 that the own apparatus is an intermediate blade or if it is decided by the process at S111 that the own apparatus is a blade 100 at the lowermost stage, a decision of No is made.

If it is decided that the own apparatus is a reference blade (S201a: Yes), the process advances to S202. Processes at S202 to S209 are similar to the processes in the first embodiment. On the other hand, if it is decided that the own apparatus is not a reference blade (S201a: No), the process advances to S203. Processes at S203 to S209 are similar to the processes in the first embodiment.

After the process at S209, the signal communication unit 90 transmits the information of the position calculated at S205 to the monitoring apparatus 230a through the network 125 (S210a).

Thereafter, the monitoring apparatus 230a receives information of the mounting position from each blade 100 and places the received information into the overall position information table 24a. By executing the series of processes described above at the given intervals of time, the monitoring apparatus 230a may update the information of the overall position information table 24a to the latest information at the given intervals of time.

According to the fifth embodiment, the overall position information table 24a is held by the monitoring apparatus and updated at the given intervals of time. According to this method, the user of the monitoring apparatus 230a may grasp the latest blade configuration of the transmission apparatus 115 without issuing a command to the transmission apparatus 215.

### Sixth Embodiment

Now, a sixth embodiment is described. In the second embodiment, a blade 100 at the uppermost stage or the lowermost stage is set as a reference blade. In contrast, in the sixth embodiment, it is characterized that one of intermediate blades is set as a reference blade.

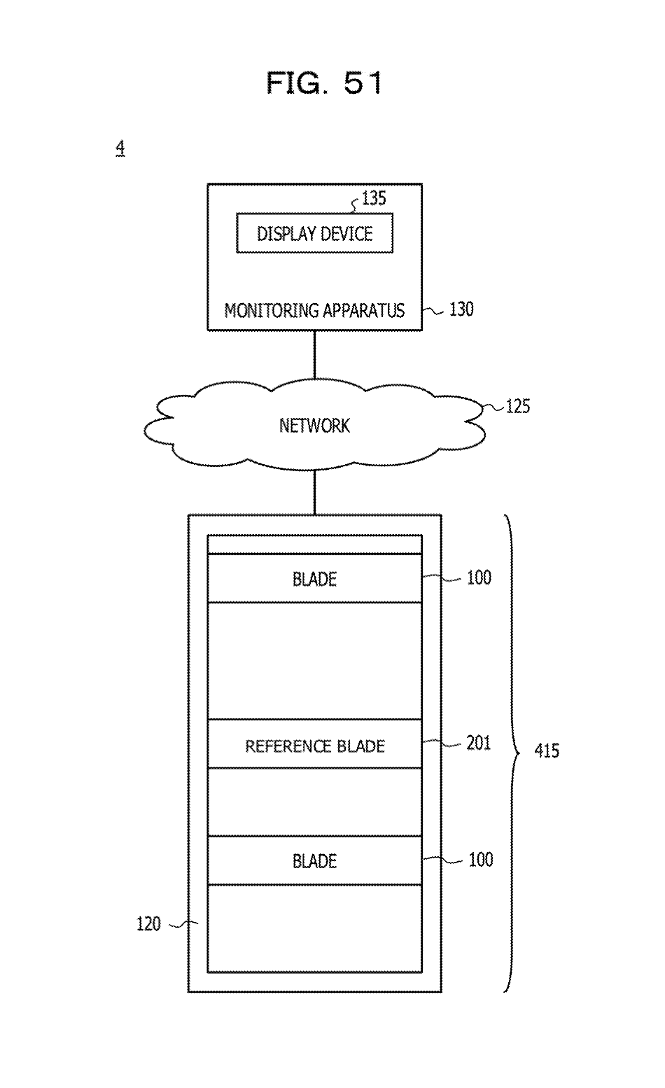

FIG. 51 is a view depicting an example of a system in the sixth embodiment. The same components to those in the first embodiment are denoted by the same reference symbols to those in the first embodiment, and description of them is omitted herein. As depicted in FIG. 51, a system 4 includes a transmission apparatus 415 and a monitoring apparatus 130. The transmission apparatus 415 and the monitoring apparatus 130 are coupled to each other by a network 125 such that they may communicate with each other.

The transmission apparatus 415 includes an open rack 120, a reference blade 201, and a plurality of blades 100 that are not set as the reference blade 201. The reference blade 201 and the plurality of blades 100 are mounted in such a manner as to be accommodated in the open rack 120. The monitoring apparatus 230 is configured similarly to the monitoring apparatus 230 in the second embodiment, and therefore, description of the monitoring apparatus 230 is omitted herein.

In the following, a process executed by the transmission apparatus 415 in the sixth embodiment is described with reference to FIGS. 22 and 23.

The transmission apparatus 415 includes an overall position information table 24 in the second storage unit 20 of the reference blade 201 that is an intermediate blade. A process for specifying a positional relationship with a different blade 100, which is executed by each of the plurality of blades 100, is similar to the process in the first embodiment illustrated in FIG. 5.

In the sixth embodiment, the reference blade 201 acquires data of a mounting position from a different blade 100 mounted above the reference blade 201 and acquires data of a mounting position from another different blade 100 mounted below the reference blade 201.

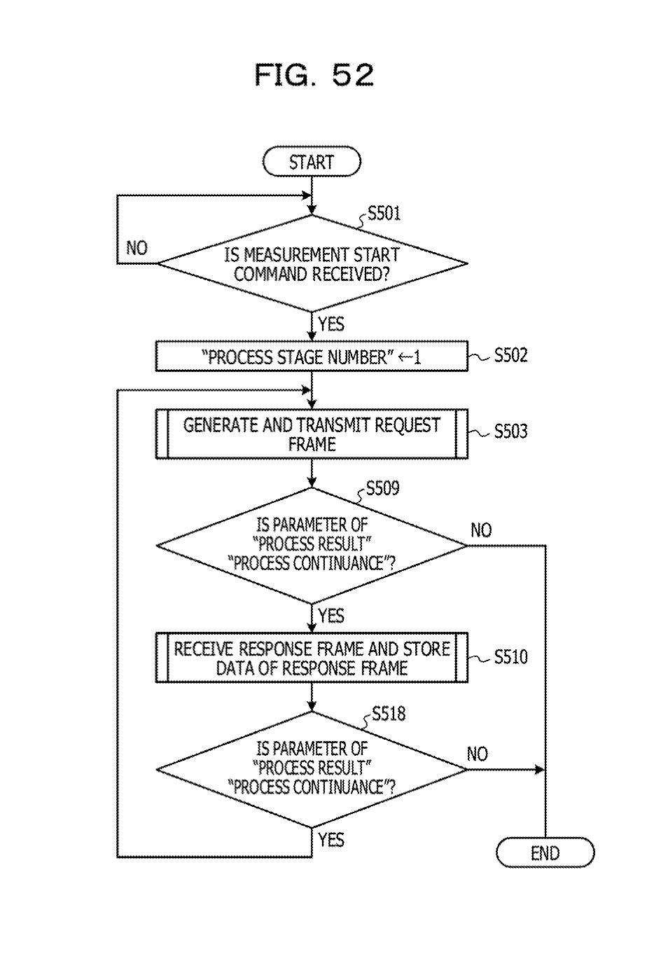

FIG. 52 is a flow chart illustrating a process for acquiring data of a mounting position from a different blade mounted above a reference blade, which is executed by the reference blade in the sixth embodiment.

Processes at S501 and S502 are similar to the processes at S301 and S302 of FIG. 25, respectively. After the process at S502, the lower face side communication unit 70 of the reference blade 201 generates a request frame and transmits the request frame to the blade 100 at the preceding stage above (S503). In the following, a process at S503 is described.

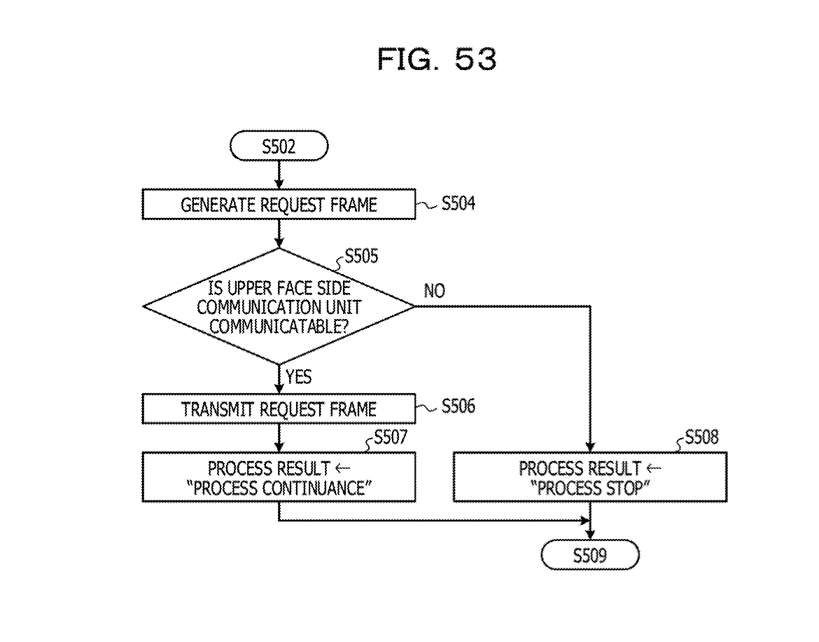

FIG. 53 is a flow chart illustrating an example of a process for transmitting a request frame in the sixth embodiment.

First, the position specification unit 30 generates a request frame (S504).

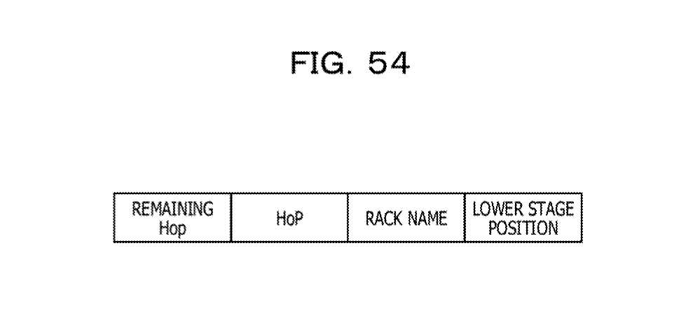

FIG. 54 is a view depicting an example of a format of a request frame in the sixth embodiment. As depicted in FIG. 54, the request frame has fields for “Remaining Hop,” “Hop,” “Rack name,” and “Lower stage position.” The fields for “Remaining Hop,” “Hop,” and “Rack name” are similar to the fields for “Remaining Hop,” “Hop,” and “Rack name” illustrated in FIG. 27, respectively. “Upper stage position” indicates a relative position of the lower face of a blade, which is a transmission source of the request frame, with respect to the position of the lower face of the reference blade 201. Since the reference blade 201 and the transmission source of the request frame at an initial stage are same as each other, in the “Lower stage position” field, information of “Null” indicating that the value of the relative distance P0 described hereinabove is zero is stored. Into the respective other fields, data are stored in accordance with the placement method described hereinabove with reference to FIG. 28.

Referring back to FIG. 53, after the process at S504, the position specification unit 30 decides whether or not the upper face side communication unit 60 is communicatable (S505). At S505, the position specification unit 30 refers to a flag corresponding to the “upper face side communication unit” stored in the communication state table 21 to decide whether or not the upper face side communication unit 60 is communicatable. If it is decided that the upper face side communication unit 60 is communicatable (S505: Yes), the upper face side communication unit 60 transmits the request frame (S506). Then, the position specification unit 30 places “process continuance” into the parameter of “process result” in the second storage unit 20 (S507). Then, the series of processes for generating the request frame is ended. On the other hand, if it is decided that the lower face side communication unit 70 is not communicatable (S505: No), the position specification unit 30 places “process stop” into the parameter of “process result” (S508). Then, the series of processes for generating a request frame is ended.

The process at S503 is executed in such a manner as described above.

Referring back to FIG. 52, after the process at S503, the position specification unit 30 decides whether or not the parameter of “process result” is “process continuance” (S509). If the parameter of “process result” is not “process continuance,” for example, is “process stop” (S509: No), the position specification unit 30 ends the series of processes by the reference blade 200. On the other hand, if the parameter of “process result” is “process continuance” (S509: Yes), the position specification unit 30 receives a response frame and places data of the response frame into the overall position information table 24 (S510). Here, a process for placing the data of the response frame into the overall position information table 24 is described.

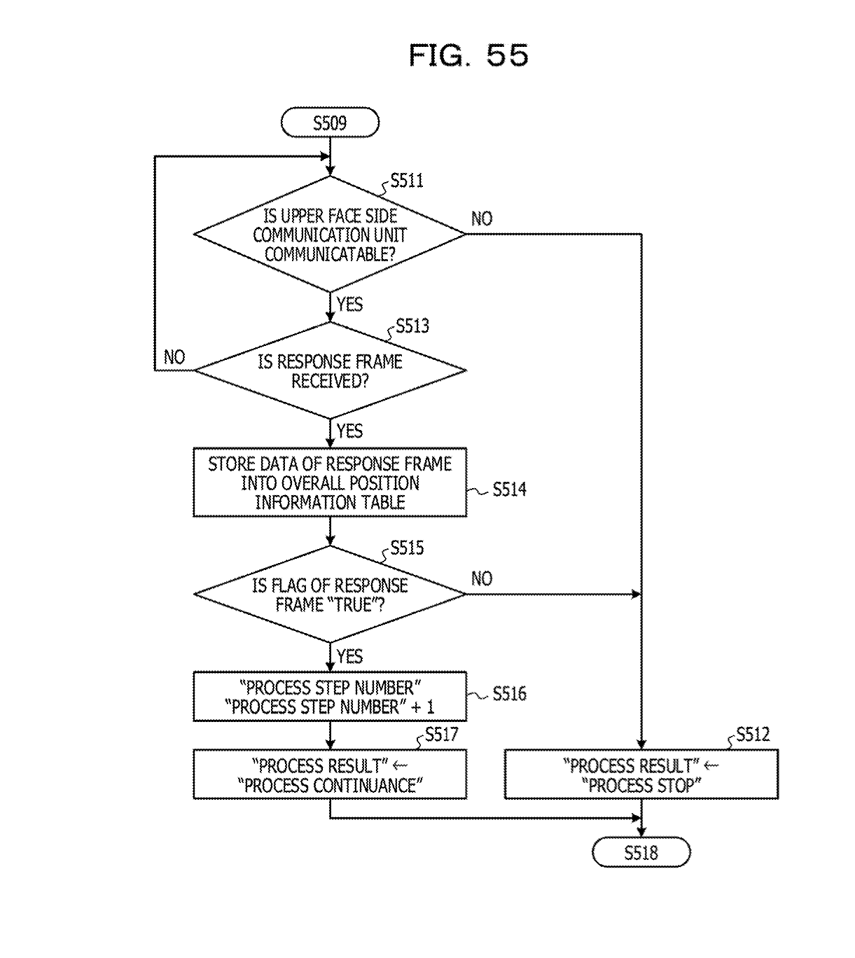

FIG. 55 is a flow chart illustrating an example of a process for placing data of a response frame at S510.

First, the position specification unit 30 decides whether or not the upper face side communication unit 60 is communicatable (S511). If it is decided that the upper face side communication unit 60 is not communicatable (S511: No), since the reference blade 200 is not capable of receiving a response from above, the position specification unit 30 places “process stop” into the parameter of “process result” (S512). Then, the series of processes for placing data of a response frame is ended. On the other hand, if it is decided that the upper face side communication unit 60 is communicatable (S511: Yes), the position specification unit 30 decides whether or not a response frame is received from above (S513).

The response frame has a format which is similar to the format illustrated in FIG. 30. However, “flag” indicates a flag for identifying, when the reference blade 200 receives a response frame from above, whether or not the blade 100 of the transmission source of the response frame is a blade at the uppermost stage. In the present embodiment, where “TRUE” is set in “flag,” the reference blade 200 may recognize that the blade 100 of the transmission source of the response frame is not a blade 100 at the uppermost stage. On the other hand, if “FALSE” is set in “flag,” the reference blade 200 may recognize that the blade 100 of the transmission source of the response frame is the blade at the uppermost stage.

If it is decided at S513 that a response frame is not received (S513: No), the process returns to S511 and the processes at the steps beginning with S511 are executed again. On the other hand, if it is decided that a response frame is received (S513: Yes), the position specification unit 30 places data of the response frame into the overall position information table 24 (S514). The processes at S514 to S512 or S517 are similar to the processes illustrated in FIG. 29.

The process at S510 is executed in such a manner as described above.

Referring back to FIG. 52, after the process at S510, the position specification unit 30 decides whether or not the parameter of “process result” is “process continuance” (S518). The process at S518 is similar to the process at S318 described hereinabove with reference to FIG. 25.

The reference blade 201 acquires data of a mounting position from a different blade 100 mounted above the reference blade in such a manner as described above.

A process for acquiring data of a mounting position from a different blade 100 mounted below the reference blade 201, which is executed by the reference blade 201, is similar to the process in the second embodiment illustrated in FIG. 25, and therefore, description of the process is omitted herein. By executing the process described above, information of the mounting position of all of the blades 100 in the open rack 120 may be stored into the overall position information table 24 of the reference blade 201.

When a user of the monitoring apparatus 130 wants to grasp the mounting position of all of the blades 100 mounted on the open rack 120, the user would transmit a request command to the reference blade 201. The reference blade 201 transmits information stored in the overall position information table 24 to the monitoring apparatus 130 in response to the request command. Then, the monitoring apparatus 130 displays the received information on the display device 135. Also in the sixth embodiment, such a display form as depicted, for example, in FIG. 21 may be used. Consequently, the user of the monitoring apparatus 130 may grasp the mounting position of all of the blades 100 mounted on the open rack 120.

According to the sixth embodiment, an intermediate blade is set as the reference blade 201. According to this method, also where a blade that holds the overall position information table 24 is mounted as an intermediate blade in an open rack, the blade may be set as the reference blade 201.

Although preferred working examples of the embodiment discussed herein are described in detail above, the embodiment discussed herein is not limited to the specific working examples and may be carried out in various modified or altered forms.

For example, although the flow chart illustrated in FIG. 13 may be applied to all blades 100 in the open rack 120, the reference blade and the blades 100 other than the reference blade may use different flow charts from each other.

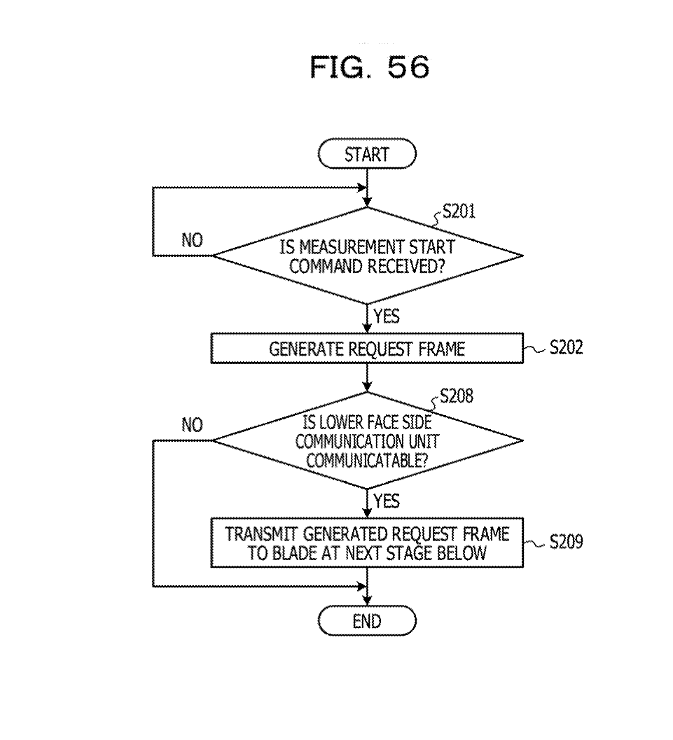

FIG. 56 is a flow chart illustrating a modification to a process for specifying a mounting position in an open rack, which is executed by a reference blade in the first embodiment. Like processes to those illustrated in FIG. 13 are denoted by the same step numbers to those in FIG. 13, and description of them is omitted herein.

First, the position specification unit 30 of the target blade decides whether or not a measurement start command is received from the monitoring apparatus 130 (S201). If it is decided that a measurement start command is received (S201: Yes), the process advances to S202 and the processes at the steps beginning with S202 are executed. Processes at S208 and S209 are similar to the processes in the first embodiment illustrated in FIG. 13. On the other hand, if it is decided at S201 that a measurement start command is not received (S201: No), the process returns to S201, and the processes at the steps beginning with S201 are executed again.

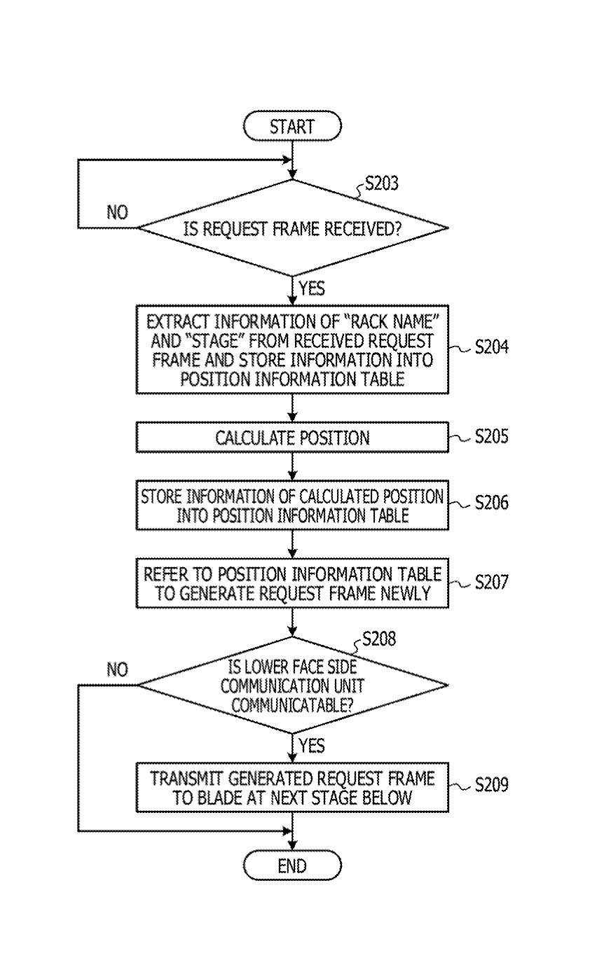

FIG. 57 is a flow chart illustrating a modification to a process for specifying a mounting position in an open rack, which is executed by a blade other than a reference blade in the first embodiment. Also in FIG. 57, like processes to those illustrated in FIG. 13 are denoted by the same step numbers to those in FIG. 13, and description of them is omitted herein.

First, the position specification unit 30 decides whether or not a request frame is received (S203). If it is decided that a request frame is not received (S203: No), the process returns to S203, and the processes at the steps beginning with S203 are executed again. On the other hand, if it is decided that a request frame is received (S203: Yes), the process advances to S204 and the processes at S204 to S209 are executed. The processes at S204 to S209 are similar to the processes in the first embodiment described hereinabove with reference to FIG. 13.

In this manner, also it is possible for the reference blade and a blade 100 other than the reference blade to execute processes of different flow charts from each other. According to the present modification, as depicted in FIGS. 57 and 58, the process flows for the reference blade and the blades 100 other than the reference blade may be simplified.

The portable terminal apparatus and control method described above, a computer program for causing a computer to execute the control program and a non-transitory computer-readable recording medium on which the program is recorded are included in the scope of the embodiment discussed herein. Here, the non-transitory computer-readable recording medium is a memory card such as a secure digital (SD) memory card. The computer program is not limited to that recorded on the recording medium. For example, the computer program may be transmitted, for example, through an electric communication line, a wireless or wire communication line, a network represented by the Internet or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A transmission apparatus comprising:
a plurality of blades mounted in a juxtaposed relationship in an open rack and including a first blade and a second blade disposed next to the first blade,
wherein the second blade includes:
a sensor, and
a processor coupled to the sensor and configured to:
receive first position information indicating a mounting position of the first blade from the first blade,
measure a distance between the first blade and the second blade using the sensor, and
calculate second position information indicating a mounting position of the second blade based on the first position information and the measured distance.

2. The transmission apparatus according to claim 1, wherein
the second blade includes a memory configured to store information of a height of the second blade, and
the processor is configured to
calculate the second position information by adding the distance and the height to the first position information.

3. The transmission apparatus according to claim 1, wherein the processor is configured to:
determine, at given intervals of time, whether a response to a response confirmation frame transmitted to a next blade is received, and
specify, based on a result of the determination, which one of a blade positioned at one end of an array of the plurality of blades, an intermediate blade positioned between two blades, and a blade positioned at another end of the array of the plurality of blades the transmission apparatus is.

4. The transmission apparatus according to claim 1, wherein
the first position information is a relative position of the first blade to a reference blade in the plurality of blades, and
the second position information is a relative position of the second blade to the reference blade.

5. The transmission apparatus according to claim 4, wherein the processor is configured to
receive, form the first blade, information of a stage number of the second blade as counted from the reference blade together with the first position information.

6. The transmission apparatus according to claim 1, wherein the processor is configured to
transmit, when it is detected that a third blade different from the first blade exists next to the second blade, the second position information to the third blade.

7. The transmission apparatus according to claim 1, wherein the processor is configured to
transmit information of the second position information indicating a mounting position of the second blade to a monitoring apparatus coupled to the transmission apparatus.

8. The transmission apparatus according to claim 7, wherein the monitoring apparatus is configured to:
store overall position information received from the plurality of blades and including information of a mounting position of each of the plurality of blades,
receive the information of the mounting position from each of the plurality of blades at given intervals of time, and
update the overall position information based on the received information of the mounting positions.

9. The transmission apparatus according to claim 4, wherein the reference blade includes a first processor configured to:
store overall position information acquired from the plurality of blades and including information of the mounting position of each of the plurality of blades, and
transmit, in response to a request from a monitoring apparatus coupled to the transmission apparatus, the overall position information to the monitoring apparatus.

10. The transmission apparatus according to claim 7, wherein the monitoring apparatus includes a second processor configured to:
generate a configuration view indicating a positional relationship between the open rack and the plurality of blades based on the information of the mounting position of each of the plurality of blades, and
display the generated configuration view on a display device.

11. A blade mounted in an open rack of a transmission apparatus, the blade comprising:
a sensor; and
a processor coupled to the sensor and configured to:
receive, from a preceding stage blade mounted next to the blade in the open rack, first position information indicating a mounting position of the preceding stage blade,
measure a distance between the preceding stage blade and the blade using the sensor, and
calculate second position information indicating a mounting position of the blade based on the first position information and the measured distance.

12. A mounting position specification method executed by a processor included in a blade mounted in an open rack of a transmission apparatus, the mounting position specification method comprising:
receiving, from a preceding stage blade mounted next to the blade in the open rack, first position information indicating a mounting position of the preceding stage blade;
measuring a distance between the preceding stage blade and the blade using the sensor; and
calculating second position information indicating a mounting position of the blade based on the first position information and the measured distance.
